(19) United States
(12) Patent Application Publication
(10) Pub. No.: US 2016/0283306 A1
(43) Pub. Date: Sep. 29, 2016

(54) INFORMATION PROCESSING APPARATUS, INFORMATION PROCESSING METHOD, AND DATA CENTER SYSTEM

(71) Applicant: FUJITSU LIMITED, Kawasaki-shi (JP)

(72) Inventors: Yusuke HAYASHI, Kawasaki (JP); Masayuki WAKITA, Yokohama (JP)

(73) Assignee: FUJITSU LIMITED, Kawasaki-shi (JP)

(21) Appl. No.: 15/015,285

(22) Filed: Feb. 4, 2016

(30) Foreign Application Priority Data
Mar. 23, 2015 (JP) 2015-059641

(51) Int. Cl. G06F 11/07

(52) U.S. Cl. CPC G06F 11/079; G06F 11/0709; G06F 11/0751; G06F 11/0772

(57) ABSTRACT

A receiving unit receives information on a failure that has occurred in each of data centers arranged in a plurality of locations. A specifying unit compares area information that indicates a characteristic related to a failure in the data center in which the failure has occurred with area information that is associated with an engineer based on a task, and specifies, as a failure handling candidate from among engineers, an engineer who is associated with area information that is similar to the area information that indicates the characteristic related to the failure in the data center in which the failure has occurred.

### CROSS-REFERENCE TO RELATED APPLICATION(S)

This application is based upon and claims the benefit of priority of the prior Japanese Patent Application No. 2015-059641, filed on Mar. 23, 2015, the entire contents of which are incorporated herein by reference.

### FIELD

The embodiments discussed herein are related to an information processing apparatus, a computer-readable recording medium, an information processing method, and a data center system.

### BACKGROUND

Conventionally, there is a technology for monitoring apparatuses, such as computers, and systems, and addressing a failure when the failure occurs in an apparatus or a system targeted for the monitoring. Furthermore, in the conventionally performed handling of failures, after a failure is detected, pieces of log information or the like on an apparatus or the like in which a failure occurs are collected and analyzed and then the handling is performed. Furthermore, failures that can be handled by specific engineers are limited to some extent. With regard to the conventional technology, see Japanese Laid-open Patent Publication No. 2011-118685, Japanese Laid-open Patent Publication No. 2006-318311, and Japanese Laid-open Patent Publication No. 2011-197785, for example.

However, if a failure occurs in a data center system constituted by a plurality of data centers, in the conventional technology, there may be a case in which it is difficult to appropriately select an engineer who handles the failure that has occurred. Thus, there is a problem in that it takes time to handle the failure that has occurred in the data center.

### SUMMARY

According to an aspect of an embodiment, an information processing apparatus includes a receiving unit and a specifying unit. The receiving unit receives information on a failure that has occurred in each of data centers arranged in a plurality of locations. The specifying unit compares area information that indicates a characteristic related to a failure in the data center in which the failure has occurred with area information that is associated with an engineer based on a task. Then, the specifying unit specifies, as a failure handling candidate from among engineers, an engineer who is associated with area information that is similar to the area information that indicates the characteristic related to the failure in the data center in which the failure has occurred.

According to another aspect of an embodiment, a computer-readable recording medium has stored therein an information processing program. The information processing program causes a computer to execute a process. The process includes: receiving information on a failure that has occurred in each of data centers arranged in a plurality of locations; comparing area information that indicates a characteristic related to a failure in the data center in which the failure has occurred with area information that is associated with an engineer based on a task; and specifying, as a failure handling candidate from among engineers, an engineer who is associated with area information that is similar to the area information that indicates the characteristic related to the failure in the data center in which the failure has occurred.

According to still another aspect of an embodiment, an information processing method includes: receiving, performed by a computer, information on a failure that has occurred in each of data centers arranged in a plurality of locations; comparing, performed by the computer, area information that indicates a characteristic related to a failure in the data center in which the failure has occurred with area information that is associated with an engineer based on a task; and specifying, performed by the computer, as a failure handling candidate from among engineers, an engineer who is associated with area information that is similar to the area information that indicates the characteristic related to the failure in the data center in which the failure has occurred.

According to still another aspect of an embodiment, a data center system includes data centers and an information processing apparatus. The data centers are arranged in a plurality of locations. The information processing apparatus includes a receiving unit and a specifying unit. The receiving unit receives information on a failure that has occurred in each of the data centers. The specifying unit compares area information that indicates a characteristic related to a failure in the data center in which the failure has occurred with area information that is associated with an engineer based on a task. The specifying unit then specifies, as a failure handling candidate from among engineers, an engineer who is associated with area information that is similar to the area information that indicates the characteristic related to the failure in the data center in which the failure has occurred.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating the hardware configuration of a data center system according to an embodiment;

FIG. 2 is a schematic diagram illustrating the functional configuration of a management center according to the embodiment;

FIG. 3 is a schematic diagram illustrating an example of the data structure of failure information;

FIG. 4 is a schematic diagram illustrating an example of the data structure of log information;

FIG. 5 is a schematic diagram illustrating an example of the data structure of requested skill information;

FIG. 6 is a schematic diagram illustrating an example of the data structure of engineer information;

FIG. 7 is a schematic diagram illustrating an example of the data structure of holding skill information;

FIG. 8 is a schematic diagram illustrating an example of the data structure of area similarity information;

FIG. 9 is a schematic diagram illustrating an example of the data structure of setting information;

FIG. 10 is a schematic diagram illustrating the functional configuration of a data center according to the embodiment;

FIG. 11 is a schematic diagram illustrating an example of the data structure of setting information;

FIG. 12 is a schematic diagram illustrating an example of the flow of a process of specifying an engineer who performs a failure handling;

FIG. 13 is a schematic diagram illustrating an example of a calculation of the similarity of logs;

FIG. 14 is a schematic diagram illustrating an example of the data structure of failure information when new data is added;

FIG. 15 is a schematic diagram illustrating an example of the data structure of log information when new data is added;

FIG. 16 is a schematic diagram illustrating an example of the flow of a process of creating a requested skill list;

FIG. 17 is a schematic diagram illustrating an example of the flow of a process of creating a failure handling candidate list;

FIG. 18 is a schematic diagram illustrating an example of the flow of a process performed after an engineer who performs the failure handling has been specified;

FIG. 19 is a schematic diagram illustrating an example of the data structure of the failure information after the failure handling has been completed;

FIG. 20 is a schematic diagram illustrating an example of the data structure of the requested skill information after the failure handling has been completed;

FIG. 21 is a schematic diagram illustrating an example of the data structure of the engineer information after the failure handling has been completed;

FIG. 22 is a schematic diagram illustrating an example of the data structure of the holding skill information after the failure handling has been completed;

FIG. 23 is a schematic diagram illustrating an example of the data structure of unregistered skill information;

FIG. 24 is a schematic diagram illustrating an example of the data structure of the requested skill information after a skill item is added;

FIG. 25 is a schematic diagram illustrating an example of the data structure of the holding skill information after the skill item is added;

FIG. 26 is a schematic diagram illustrating an example of the flow of a process in the data center when a failure is detected;

FIG. 27 is a schematic diagram illustrating an example of the flow of a process in which a failure management server creates a requested skill;

FIG. 28 is a schematic diagram illustrating an example of the flow of a process in which the failure management server creates the requested skill;

FIG. 29 is a schematic diagram illustrating an example of the flow of a process in which the failure management server creates the requested skill;

FIG. 30 is a schematic diagram illustrating an example of the flow of a process in which the failure management server creates the failure handling candidate list;

FIG. 31 is a schematic diagram illustrating an example of the flow of a process in which the failure management server creates the failure handling candidate list;

FIG. 32 is a schematic diagram illustrating an example of the flow of a process in which the failure management server creates a failure handling candidate list;

FIG. 33 is a schematic diagram illustrating an example of the flow of a notification process performed with respect to a failure contact desk;

FIG. 34 is a schematic diagram illustrating an example of the flow of a registration process after an engineer who is in charge of a failure has been specified;

FIG. 35 is a schematic diagram illustrating an example of the flow of a process of registering the failure information;

FIG. 36 is a schematic diagram illustrating an example of the flow of a registration process after the failure is handled;

FIG. 37 is a schematic diagram illustrating an example of the flow of the registration process after the failure is handed;

FIG. 38 is a schematic diagram illustrating an example of the flow of a process of adding a skill item;

FIG. 39 is a schematic diagram illustrating an example of the flow of an update process of area similarity; and

FIG. 40 is a block diagram illustrating a computer that executes an information processing program.

### DESCRIPTION OF EMBODIMENTS

Preferred embodiments of the present invention will be explained with reference to accompanying drawings. In the embodiment, it is assumed that the present invention is used in a data center system that includes a plurality of data centers that provide virtual machines. Furthermore, the present invention is not limited to the embodiment. The embodiments can be appropriately used in combination as long as processes do not conflict with each other.

Configuration of a Data Center System According to an Embodiment

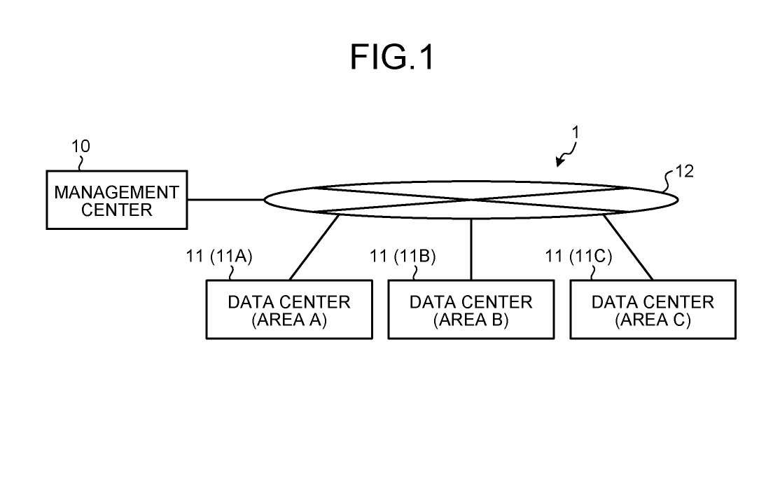

FIG. 1 is a schematic diagram illustrating the hardware configuration of a data center system according to an embodiment. As illustrated in, a data center system 1 includes a management center 10 and a plurality of data centers (DCs) 11. The management center 10 and the plurality of the data centers 11 are connected by a network 12. The network 12 may also be a dedicated line or may also be a non-dedicated line. In the example illustrated in FIG. 1, the three data centers 11 (11A, 11B, and 11C) are illustrated; however, an arbitrary number of the data centers 11 may also be used as long two or more data centers are used.

The management center 10 manages the plurality of data centers 11. For example, in accordance with the occurrence of failure, the management center 10 analyzes the failure state, estimates a requested skill, and specifies an appropriate engineer. Furthermore, the management center 10 may also be integrated with one of the data centers 11.

The data centers 11 are arranged in geographically separate locations with each other. In the embodiment, it is assumed that each of the data centers 11 is arranged in a different region, such as a different country. For example, it is assumed that the data centers 11A, 11B, and 11C are set in an area A, an area B, and an area C, respectively. Furthermore, in the embodiment, a description will be given of a case, as an example, in which the three data centers 11A, 11B, and 11C are set in the area A, the area B, and the area C, respectively; however, two or more of the management centers 10 may also be set in the same area. Furthermore, each of the data centers 11 may also be communicated with each other. Furthermore, in a described below, when the data centers 11A, 11B, and 11C are described without distinction, the data centers 11A, 11B, and 11C are referred to as the data center 11.

Hardware Configuration of the Management Center

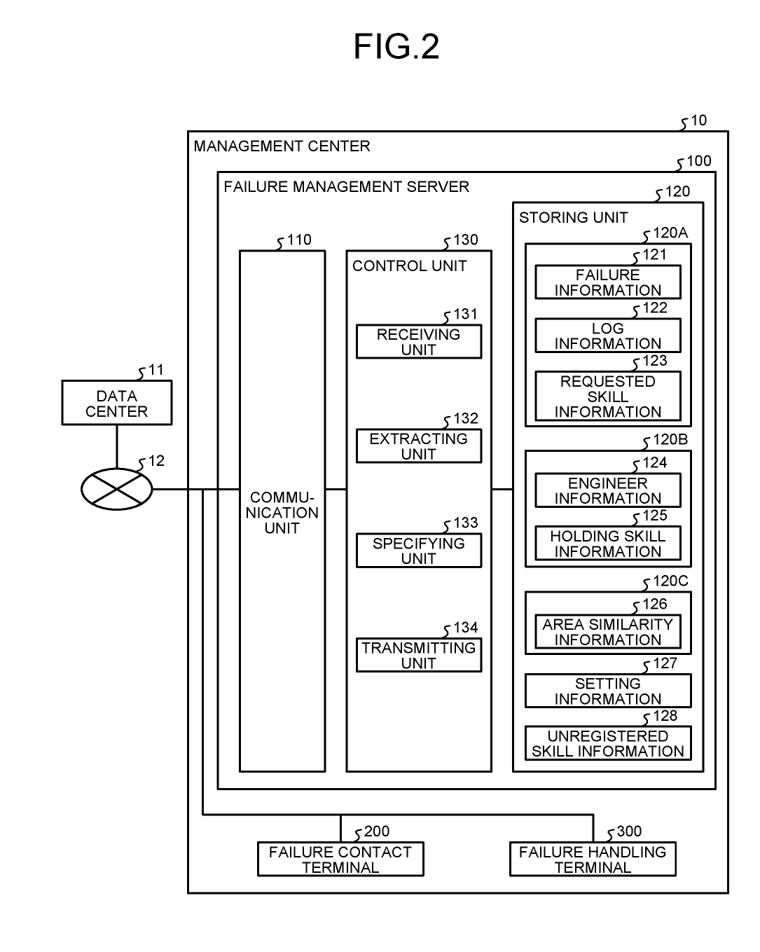

In the following, the functional configuration of the management center 10 will be described with reference to FIG. 2. FIG. 2 is a schematic diagram illustrating the functional configuration of a management center according to the embodiment.

The management center 10 includes a failure management server 100, a failure contact terminal 200, and a failure handling terminal 300. The failure management server 100, the failure contact terminal 200, and the failure handling terminal 300 are connected by, for example, a network inside the management center 10 and are communicated with each other. The network inside the management center 10 is connected to the network 12 such that they can communicate with each other and the network can be communicated with the data center 11 via the network 12. Furthermore, in the example illustrated in FIG. 2, a single number of the failure management server 100 is illustrated; however, two or more of the failure management server 100 may also be used.

The failure management server 100 is an information processing apparatus that analyzes, in accordance with a failure in the data center 11, a failure state, estimates a requested skill, and specifies an appropriate engineer. For example, if the failure management server 100 receives information related to the failure that has occurred in the data center 11, the failure management server 100 specifies, as a failure handling candidate on the basis of area information that indicates the characteristic related to the occurrence of the failure in the data center 11 in which the failure has occurred, an engineer who handles the failure. In a description below, a description will be given of a case in which the failure management server 100 receives a notification of the occurrence of the failure in the data center 11 as the information related to the failure that has occurred in the data center 11.

Furthermore, the failure contact terminal 200 and the failure handling terminal 300 are implemented by, for example, a desktop personal computer (PC), a notebook PC, a tablet type terminal, a mobile phone device, a personal digital assistant (PDA), or the like. For example, the failure contact terminal 200 is used by a contact person who performs the contact task of a failure. For example, the failure handling terminal 300 is used by a failure handling candidate. In a description below, the failure contact terminal 200 may sometimes be referred to as a failure contact person. Namely, in a description below, a failure contact person can alternatively be read as the failure contact terminal 200. Furthermore, in a description below, the failure handling terminal 300 may sometimes be referred to as a failure handling candidate. Namely, in a description below, the failure handling candidate can alternatively be read as the failure handling terminal 300.

Configuration of the Failure Management Server (Information Processing Apparatus)

In the following, the configuration of the failure management server 100 according to the first embodiment will be described. As illustrated in FIG. 2, the failure management server 100 includes a communication unit 110, a storing unit 120, and a control unit 130. Furthermore, in addition to the functioning units illustrated in FIG. 2, the failure management server 100 may also include various kinds of functioning units included in a known computer. For example, the failure management server 100 may also include a displaying unit that displays various kinds of information or an input unit to which various kinds of information is input.

The communication unit 110 is implemented by, for example, a network interface card (NIC). The communication unit 110 is connected to, for example, the network 12 in a wired or a wireless manner. Then, the communication unit 110 sends and receives information to and from the data center 11 via the network 12. Furthermore, the communication unit 110 sends and receives information to and from the failure contact terminal 200 or the failure handling terminal 300 via, for example, the network inside the management center 10.

The storing unit 120 is a database that includes a storage device that stores therein various kinds of data. For example, the storing unit 120 includes, as a storage device, a hard disk, a solid state drive (SSD), an optical disk, or the like. Furthermore, the storing unit 120 may also use, as a storage device, a semiconductor memory, such as a random access memory (RAM), a flash memory, a nonvolatile static random access memory (NVSRAM), or the like, that can rewrite data.

The storing unit 120 stores therein an operating system (OS) or various kinds of programs that are executed in the control unit 130. For example, the storing unit 120 stores therein various kinds of programs including a program that executes a process of specifying an engineer, which will be described later. Furthermore, the storing unit 120 stores therein various kinds of data that are used by the programs executed in the control unit 130. The storing unit 120 according to the embodiment includes a failure handling recording database 120A, a failure handling person database 120B, and an area similarity database 120C. In the failure handling recording database 120A, failure information 121, log information 122, and requested skill information 123 are stored. In the failure handling person database 120B, engineer information 124, and holding skill information 125 are stored. Furthermore, in the area similarity database 120C, area similarity information 126 is stored. The storing unit 120 stores therein setting information 127 and unregistered skill information 128.

The failure information 121 is data that stores therein information related to a failure that has occurred in the data center system 1. For example, the failure information 121 stores therein information, such as the storage location of a file in which the content of a failure that has occurred in the data center system 1 is described for each failure; the storage location of a file in which the handling content of the failure is described; the status that indicates the handling state of the failure; the engineer who performed the handling; and the like.

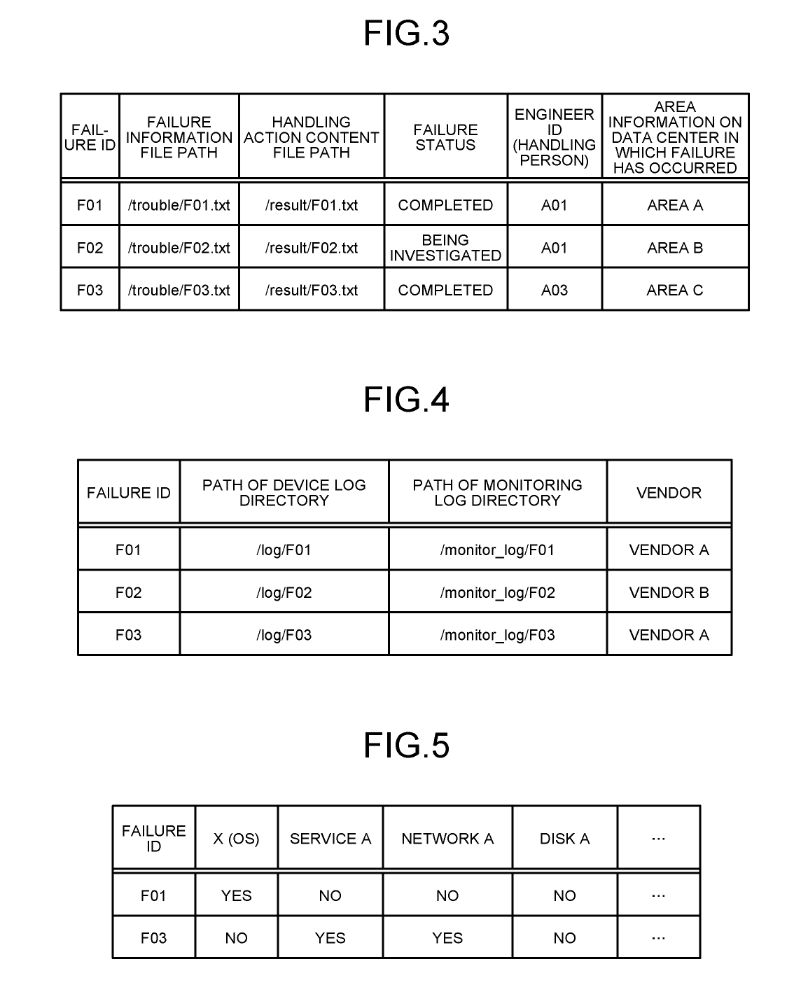

FIG. 3 is a schematic diagram illustrating an example of the data structure of failure information. As illustrated in FIG. 3, the failure information 121 has items of the “failure ID”, the “failure information file path”, the “handling action content file path”, the “failure status”, the “engineer ID (handling person)”, and the “area information on a data center in which a failure has occurred”.

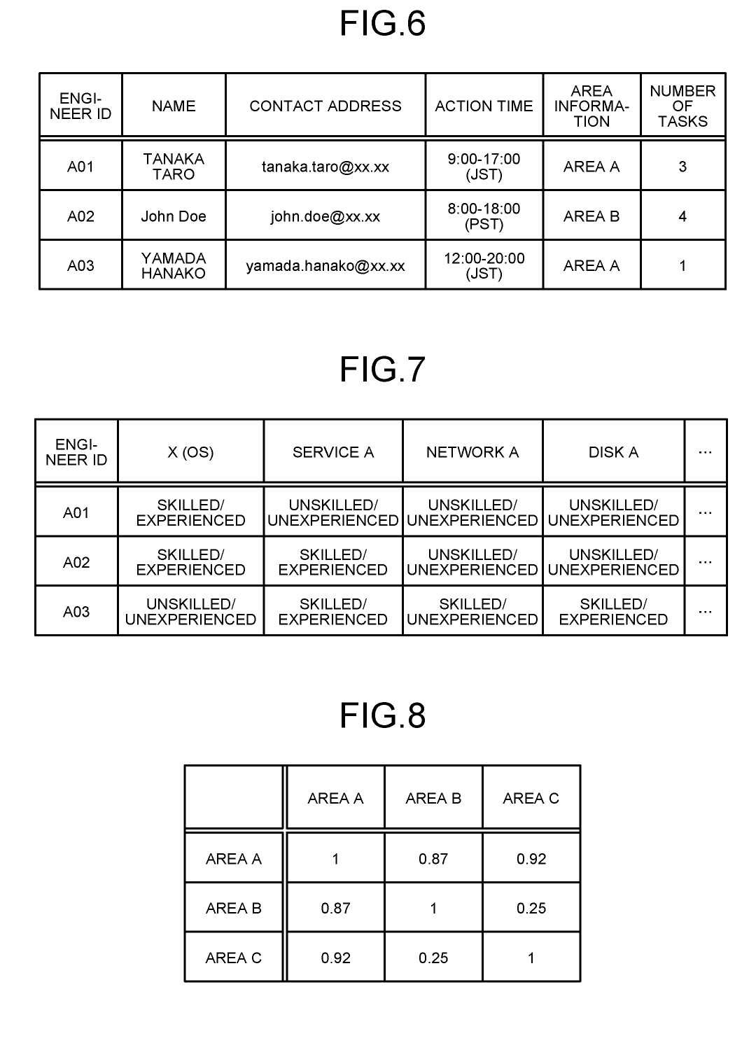

The item of the failure ID is an area that stores therein identification information that identifies a failure that has occurred in the data center system 1. A failure ID is attached to the failure that has occurred in the data center system 1 as the identification information that identifies each of the data center. In the item of the failure ID, the failure ID that is attached to the failure that has occurred in the data center system 1 is stored. The item of the failure information file path is an area that stores therein the storage location of a file in which the content of the failure that is identified by the failure ID is described. The item of the handling action content file path is an area that stores therein the storage location of a file in which the content of the handling with respect to the failure that is identified by the failure ID is described. The item of the failure status is an area that stores therein the handling status of the failure that is identified by the failure ID. The item of the engineer ID is an area that stores therein identification information that identifies an engineer who handles the failure that has occurred in the data center system 1. A description thereof in detail will be described with reference to FIG. 6; however, an engineer ID is attached to, as the identification information that identifies each of the engineers, the engineer who is a contact person who handles the failure that has occurred in the data center system 1. Furthermore, if a plurality of engineers handles a failure, a plurality of engineer IDs may also be stored. The item of the area information on the data center in which a failure has occurred is an area that stores therein the area in which the failure has occurred. Furthermore, the geographical characteristic of the data center in which the failure has occurred may also be associated with the area information; however, the geographical characteristic will be described in detail later.

The example illustrated in FIG. 3 indicates that, for the failure identified by “F01”, the file in which the content of the subject failure is described is stored in “/trouble/F01.txt” and the file in which the handling content of the subject failure is described is stored in “/result/F01.txt”. Furthermore, the example illustrated in FIG. 3 indicates that, for the failure identified by “F01”, the handling has been completed and the engineer who performed the subject handling is the engineer identified by “A01”. Furthermore, the example illustrated in FIG. 3 indicates that the failure identified by “F01” has occurred in the area A.

The log information 122 is data that stores therein log information related to a failure that has occurred in the data center system 1. For example, in the log information 122, the log information acquired from the data center 11 in which the failure has occurred is included. For example, the log information 122 stores therein information, such as the storage location of a file in which a device log acquired from the data center 11 in which a failure has occurred is described; the storage location of a file in which a monitoring log acquired from the data center 11 in which a failure has occurred is described; a vendor name of a device in which a failure has occurred; and the like.

FIG. 4 is a schematic diagram illustrating an example of the data structure of log information. As illustrated in FIG. 4, the log information 122 has items of the “failure ID”, the “path of a device log directory”, the “path of a monitoring log directory”, and the “vendor”.

The item of the failure ID is an area that stores therein the identification information that identifies the failure that has occurred in the data center system 1. The item of the path of a device log directory is an area that stores therein the storage location of a file of the log information that is acquired from the device in which the failure identified by the failure ID has occurred. The item of the path of a monitoring log directory is an area that stores therein the storage location of a file of the log information that is acquired from the monitoring server that monitors the device in which the failure identified by the failure ID has occurred. The item of the vendor is an area that stores therein vendor information, such as a manufacturing name, serial number of the device, or the like, that related to the device in which the failure identified by the failure ID has occurred.

The example illustrated in FIG. 4 indicates that, for the failure identified by “F02”, the device log is stored in “/log/F02” and the monitoring log is stored in “/monitor_log/F02”. Furthermore, the example illustrated in FIG. 4 indicates that the vendor of the device in which the failure that is identified by “F02” has occurred is the vendor B.

The requested skill information 123 is data that stores therein information indicating whether an engineer who handles each failure occurring in the data center system 1 is requested to have an ability to handle the failure (hereinafter, sometimes referred to as a “skill”). For example, the requested skill information 123 stores therein, for each failure, information indicating whether a skill related to each of the various kinds of OSs, various kinds of services, various kinds of networks, and various kinds of data storage (for example, disk) are requested.

FIG. 5 is a schematic diagram illustrating an example of the data structure of requested skill information. As illustrated in FIG. 5, the requested skill information 123 has items of a “failure ID”, an “X (OS)”, a “service A”, a “network A”, a “disk A”, and the like.

The item of the failure ID is an area that stores therein the failure ID attached to a failure that has occurred in the data center system 1. The item of the X (OS) is an area that stores therein information indicating whether the skill related to the X (OS) has been requested to handle the failure identified by the failure ID. The item of the service A is an area that stores therein information indicating whether the skill related to the service A has been requested to handle the failure identified by the failure ID. The item of the network A is an area that stores therein is an area that stores therein information indicating whether the skill related to the network A has been requested to handle the failure identified by the failure ID. The item of the disk A is an area that stores therein information indicating whether the skill related to the disk A has been requested to handle the failure identified by the failure ID.

The example illustrated in FIG. 5 indicates that, for the handling of the failure that is identified by “F03”, the skills related to the X (OS) and the disk A are not requested. Furthermore, the example illustrated in FIG. 5 indicates that, for the handling of the failure that is identified by “F03”, the skills related to the service A and the network A are requested. Furthermore, the example illustrated in FIG. 5 indicates that the skill requested for the failure “F02” in which the handling has not been completed is not stored; however, for the failure “F02” that is being investigated, a skill requested at the step of being investigated may also be stored.

The engineer information 124 is data that stores therein information about the engineers registered in the data center system 1. For example, the engineer information 124 is data that stores therein information about the engineers belonging to each of the data centers. Furthermore, for example, the engineer information 124 stores therein information about the engineer ID, the name, the contact address of an engineer, the action time of an engineer, the data center to which an engineer belongs, the language that can be used by an engineer, and the like.

FIG. 6 is a schematic diagram illustrating an example of the data structure of engineer information. As illustrated in FIG. 6, the engineer information 124 has items of the “engineer ID”, the “name”, the “contact address”, the “action time”, the “area information”, and the “number of tasks”.

The item of the engineer ID is an area that stores therein the identification information that identifies the engineers registered in the data center system 1. An engineer ID is attached to each of the engineers registered in the data center system 1 as the identification information that identifies each of the engineers. The item of the engineer ID stores therein the engineer ID that is attached to each of the engineers registered in the data center system 1. The item of the name is an area that stores therein the name of the engineer identified by the engineer ID. The item of the contact address is an area that stores therein the contact address (for example, an email address, a phone number, or the like) of the engineer identified by the engineer ID. The item of the action time is an area that stores therein the time occupied by the engineer identified by the engineer ID. The item of the area information is an area that stores therein the area information associated with an engineer on the basis of a task. For example, the item of the area information is an area that stores therein an area in which the data center belonging to the engineer identified by the engineer ID is located. The item of the number of tasks is an area that stores therein the number of tasks that is being handled by the engineer identified by the engineer ID. Furthermore, the engineer information 124 is not limited to the information indicated the above and may also include therein various kinds of information, such as information on a non-working day of an engineer.

The example illustrated in FIG. 6 indicates that, for the engineer identified by “A01”, the name of the engineer is “Tanaka Taro”, the contact address is “tanaka.taro@xx.xx”, and the action time is 9:00 to 17:00 (JST). Furthermore, the example illustrated in FIG. 6 indicates that, for the engineer identified by “A01”, the location area of the data center to which the engineer belongs is the “area A” and the number of tasks that are being handled is “3”. Furthermore, “JST” indicated in the column of the “action time” illustrated in FIG. 6 stands for Japan Standard Time and “PST” stands for Pacific Standard Time. Furthermore, the area that is associated with each of the engineers is not limited to the location area of the data center 11 to which an engineer belongs. The area in which an engineer has an experience of handling a failure may also be associated with the engineer. In the example illustrated in FIG. 6, because, for the engineer identified by the engineer ID “A03”, the data center 11 to which the engineer belongs is located in the area A, the “area A” is stored in the area information that is associated with the engineer ID “A03”. Furthermore, the area information on the data center in which the engineer handled a failure in the past may also be associated with the engineer. For example, as illustrated in FIG. 3, the engineer identified by “A03” has the experience of handling the failure that is identified by the failure ID “F03” and that is the failure occurred in the area C. Thus, in addition to the “area A”, the “area C” may also be stored in the area information that is associated with the engineer ID “A03”. As described above, for the engineer information, a plurality of areas may also be stored in the area information that is associated with each of the engineer IDs.

The holding skill information 125 is data that stores therein information related to the skills held by the engineers registered in the data center system 1. For example, the holding skill information 125 stores therein, for each failure, information indicating whether an engineer has the skill related to various kinds of OSs, whether an engineer has the skill related to various kinds of services, whether an engineer has the skill related to various kinds of networks, and the like.

FIG. 7 is a schematic diagram illustrating an example of the data structure of holding skill information. As illustrated in FIG. 7, the holding skill information 125 has items of the “engineer ID”, the “X (OS)”, the “service A”, the “network A”, the “disk A”, and the like.

The item of the engineer ID is an area that stores therein the engineer ID attached to the engineer registered in the data center system 1. The item of the X (OS) is an area that stores therein information indicating whether the engineer identified by the engineer ID has the skill related to the X (OS) or the like. The item of the service A is an area that stores therein information indicating whether the engineer identified by the engineer ID has the skill related to the service A or the like. The item of the network A is an area that stores therein information indicating whether the engineer identified by the engineer ID has the skill related to the network A or the like. The item of the disk A is an area that stores therein information indicating whether the engineer identified by the engineer ID has the skill related to the disk A or the like.

The example illustrated in FIG. 7 indicates that the engineer identified by “A01” has the skill and the experience that are related to the X (OS). Furthermore, the engineer identified by “A01” does not have the skill and the experience that are related to the service A, the network A, and the disk A.

The area similarity information 126 is data that stores therein the information related to the similarity between each of the data centers 11. For example, the area similarity information 126 stores therein the information related to the similarity of each of the area A, the area B, and the area C. Here, in the embodiment, the similarity takes values from 0 to 1. The area with the value of the similarity that is closer to 0 indicates dissimilarity, whereas the area with the value of the similarity that is closer to 1 indicates similarity. Furthermore, the similarity is calculated on the basis of the area information that indicates the characteristic related to the occurrence of a failure in the data center in which the failure occurs and that is created for each area. For example, the similarity between the areas in which similar failures occur may also be made to high. Furthermore, for example, the similarity between the areas similar in climate may also be made to high.

FIG. 8 is a schematic diagram illustrating an example of the data structure of area similarity information. As illustrated in FIG. 5, the area similarity information 126 has items of the “area A”, the “area B”, the “area C”, and the like.

The item of the area A is an area that stores therein the similarity to the area A. The item of the area B is an area that stores therein the similarity to the area B. The item of the area C is an area that stores therein the similarity to the area C.

The example illustrated in FIG. 8 indicates that, for the area A, the similarity to the area A is 1, the similarity to the area B is 0.87, and the similarity to the area C is 0.92. Namely, the example illustrated in FIG. 8 indicates that the similarity of area A to the area B and to the area C is high. Furthermore, the example illustrated in FIG. 8 indicates that the similarity of the area B to the area A is 0.87, similarity to the area B is 1, and the similarity to the area C is 0.25. Namely, the example illustrated in FIG. 8 indicates that the similarity of the area B to the area A is high and the similarity of the area B to the area C is low.

Setting information 127 is data that stores therein a defined value needed for each process. For example, the setting information 127 stores therein the information, such as the file name of a device log, the file name of a monitoring log, a parent directory name that loads a device log, a parent directory name that loads a monitoring log, a threshold used to determine the similarity of log information, a threshold used to determine the skill of an engineer, and the like.

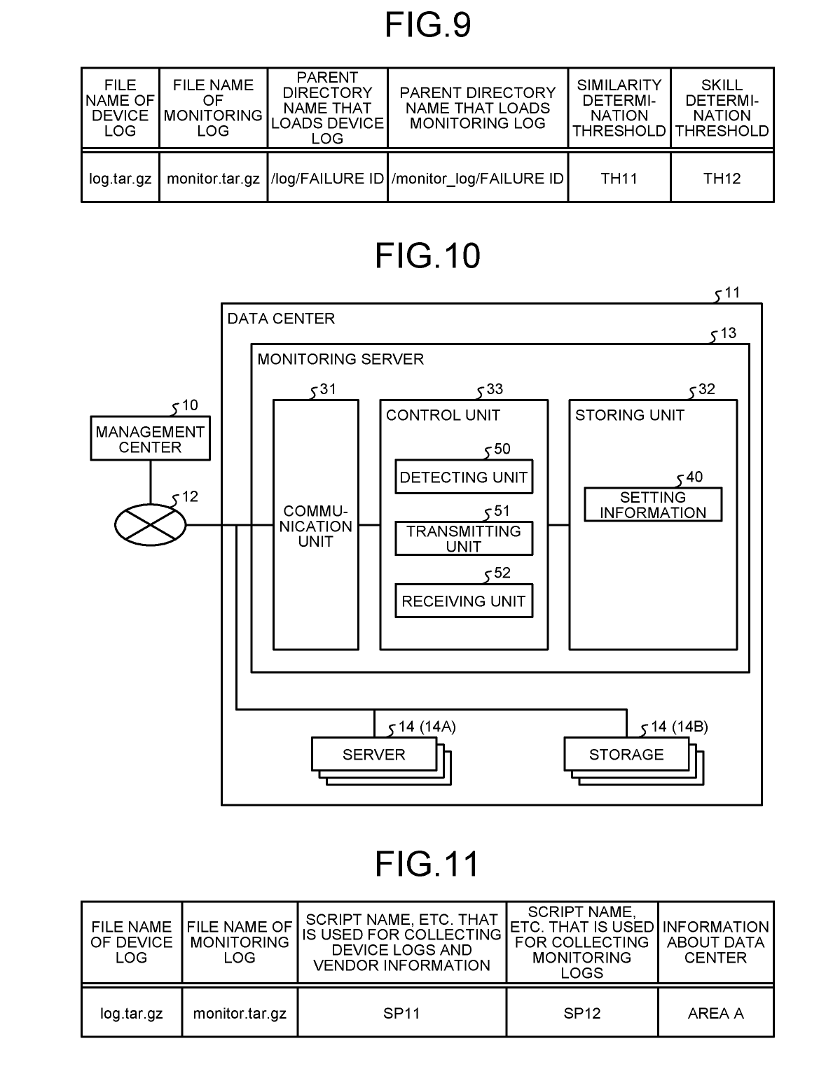

FIG. 9 is a schematic diagram illustrating an example of the data structure of setting information. As illustrated in FIG. 9, the setting information 127 has items of the “file name of a device log”, the “file name of a monitoring log”, the “parent directory name that loads a device log”, and the “parent directory name that loads a monitoring log”. Furthermore, the setting information 127 has items of the “similarity determination threshold”, the “skill determination threshold”, and the like.

The item of the file name of a device log is an area that stores therein the file name of the device log received from the data center 11. The item of the file name of a monitoring log is an area that stores therein the file name of the monitoring log received from the data center 11. The parent directory name that loads a device log is an area that stores therein the parent directory name that loads the received device log. The parent directory name that loads a monitoring log is an area that stores therein the parent directory name that loads the received monitoring log. The similarity determination threshold is an area that stores therein the threshold that is used to determine the similarity of the log information. The skill determination threshold is an area that stores therein the threshold that is used to determine whether an engineer has a sufficient skill.

The example illustrated in FIG. 9 indicates that the file name of the device log is “log.tar.gz” and the file name of the monitoring log is “monitor.tar.gz”. Furthermore, the example illustrated in FIG. 9 indicates that the parent directory name that loads the device log is “/log/failure ID” and the parent directory name that loads the monitoring log is “/monitor_log/failure ID”. Furthermore, the example illustrated in FIG. 9 indicates that the similarity determination threshold is “TH11” and the skill determination threshold is “TH12”. For example, the similarity determination threshold indicates the threshold of the similarity that is used to determine the similarity between the areas. For example, the skill determination threshold indicates the threshold of the number of records of failures that is used to determine the skill.

A description will be given here by referring back to FIG. 2. The control unit 130 is a device that controls the failure management server 100. As the control unit 130, an electronic circuit, such as a central processing unit (CPU), a micro processing unit (MPU), and the like, or an integrated circuit, such as an application specific integrated circuit (ASIC), a field programmable gate array (FPGA), and the like, may be used. The control unit 130 includes an internal memory that stores therein control data and programs in which various kinds of procedures are prescribed, whereby various kinds of processes are executed. The control unit 130 functions as various kinds of processing unit by various kinds of programs being operated. For example, the control unit 130 includes a receiving unit 131, an extracting unit 132, a specifying unit 133, and a transmitting unit 134.

The receiving unit 131 receives information related to a failure that has occurred each of the data centers 11. For example, if a failure occurs in the data center 11, the receiving unit 131 receives information that is sent from the data center 11 and that is related to the failure that has occurred.

The extracting unit 132 extracts engineers who can handle the failure that has occurred. For example, the extracting unit 132 may also determine, on the basis of the various kinds of log information received from the data center 11, the type of the failure that has occurred. In this case, the extracting unit 132 may also determine, on the basis of various kinds of technologies, the content of the failure that has occurred.

The extracting unit 132 extracts the engineers who can handle the failure on the basis of, for example, the skills of the engineers stored in the holding skill information 125 in the storing unit 120. For example, the extracting unit 132 estimates, from the information related to the past failure handling, such as the failure information 121, the requested skill information 123, or the like, the skill that is requested to handle the failure detected by the receiving unit 131. For example, the extracting unit 132 may also search the failure information 121 in the storing unit 120 for a past failure in which the same problem as that currently occurs in the current failure and may also estimate the skill requested by the searched past failure as the skill that is currently requested to handle the failure that has occurred. Furthermore, the extracting unit 132 may also estimate the skill requested for the failure in which the same problem occurred in the past and that is being investigated as the skill requested to handle the failure that has occurred.

The extracting unit 132 extracts engineers who have the estimated skill. Specifically, if a failure related to software has occurred, the extracting unit 132 extracts an engineer who has the estimated skill and the time at which the failure has occurred falls on the action time of the subject engineer. For example, in the examples illustrated in FIGS. 3 to 8, if a failure occurs at 13:00 (JST) and the skill of the service A is requested to handle the subject failure, at least the engineer with the engineer ID “A03” is extracted. Furthermore, if, for example, the date in which the failure occurs falls on a non-working day of an engineer stored in the engineer information 124, the extracting unit 132 does not need to extract the subject engineer.

When the extracting unit 132 estimates the skill requested to handle the failure that is detected by the receiving unit 131, the extracting unit 132 may also extract the engineer who can handle the failure by taking into account the experience of the skill. For example, if the experience is also requested, in addition to the skill of the “network A”, for the failure that has occurred, the extracting unit 132 does not need to extract the engineer “A03” who has the skill of the “network A” but has no experience. Furthermore, if the extracting unit 132 estimates a plurality of skills requested to handle the failure received from the receiving unit 131, the extracting unit 132 may also extract only the engineer who has all of the skills that are estimated as the requested skills. Furthermore, the extracting unit 132 may also extract an engineer who has skills the number of which is equal to or greater than a predetermined number of skills from among the plurality of skills estimated as the requested skills. For example, if the number of skills estimated as the requested skills is five, the extracting unit 132 may also extract an engineer who has three skills out of the requested five skills. Furthermore, the extracting unit 132 may also allocate a weighting value to each of the plurality of skills estimated as the requested skills and extract an engineer who has skills in which the sum of the weighting value held by the engineer exceeds a threshold. Furthermore, the extracting unit 132 may also classify the plurality of skills estimated as the requested skills into fundamental skills and optional skills and extract an engineer who has the fundamental skills and has the optional skills the number of which is equal to or greater than a predetermined number. The extraction of an engineer, performed by the extracting unit 132, who handles a failure is only an example and the extracting unit 132 may also extract an engineer on the basis of various criteria in accordance with a failure that has occurred or in accordance with a purpose of the handling.

Furthermore, if a plurality of extracted engineers is present, the extracting unit 132 may also prioritize the plurality of extracted engineer. In this case, the extracting unit 132 may also give a higher priority to an engineer whose action time is longer from the time at which the failure has occurred. For example, if a failure occurs at 13:00 (JST) and if the engineer “A01” and the engineer “A03” are extracted as the available engineers, the extracting unit 132 may also give the first priority to the engineer “A03” whose action time is longer from 13:00 (JST). Furthermore, the extracting unit 132 may also give a higher priority to an engineer who has a greater number of skills that are estimated as the requested skills. Furthermore, the extracting unit 132 may also give a higher priority to an engineer who has skills in which the sum of weighting values is greater. The prioritization of engineers who handles the failure by the extracting unit 132 described above is only an example and the extracting unit 132 may also prioritize the engineers on the basis of various criteria in accordance with a failure that has occurred or in accordance with a purpose of the handling.

The specifying unit 133 specifies, as a failure handling candidate, the engineer who handles the failure from among the engineers extracted by the extracting unit 132. For example, if two engineers with the engineer ID of “A01” and “A02” are extracted by the extracting unit 132, the specifying unit 133 specifies, between the two engineers “A01” and “A02” as the failure handling candidates, the engineer who is allowed to handle the failure. The specifying unit 133 specifies the failure handling candidate on the basis of the comparison between the area information that indicates the characteristic related to the failure occurrence in the data center 11 in which the failure has occurred and the area information that is associated with the engineer on the basis of the task. For example, the specifying unit 133 specifies, as the failure handling candidate, the engineer associated with the area information that is similar to the area information on the data center 11 in which the failure has occurred. For example, if a failure occurs in the data center 11C located in the area C and if two engineers with the engineer ID of “A01” and “A02” are extracted by the extracting unit 132, the specifying unit 133 specifies the failure handling candidate on the basis of the area associated with each of the engineers. In this case, the area associated with the engineer with the engineer ID “A01” is the area A and the similarity to the area C in which the failure has occurred is 0.92. In contrast, the area associated with the engineer with the engineer ID “A02” is the area B and the similarity to the area C in which the failure has occurred is 0.25. Consequently, the specifying unit 133 specifies the engineer with the engineer ID “A01” associated with the area having a higher similarity as the failure handling candidate. Furthermore, the extracting unit 132 and the specifying unit 133 may also be integrated as a specifying unit.

The transmitting unit 134 sends various kinds of information to the data center 11. For example, specifically, the transmitting unit 134 may also send the information related to the engineer specified by the specifying unit 133 to the data center 11 in which a failure occurs.

Hardware Configuration of the Data Center

In the following, the functional configuration of the data center 11 will be described with reference to FIG. 10. FIG. 10 is a schematic diagram illustrating the functional configuration of the data center according to the embodiment.

The data center 11 includes a monitoring server 13, a plurality of servers 14A, and a plurality of storage media 14B. Furthermore, the plurality of the servers 14A and the plurality of the storage media 14B are targets for monitoring, by the monitoring server 13, whether a failure has occurred. When the servers 14A and the storage media 14B are described without distinction, the servers 14A and the storage media 14B are referred to as monitored devices 14. The monitoring server 13 and the plurality of the monitored devices 14 are connected by, for example, the network inside the data center 11 and can be communicated with each other. The network inside the data center 11 is connected to the network 12 such that they can communicate with each other and the network can be communicated with the management center 10 or the other data centers 11 via the network 12. Furthermore, in the example illustrated in FIG. 10, a single number of the monitoring server 13 is illustrated; however, two or more of the monitoring server 13 may also be used.

The monitoring server 13 is, for example, a server device that monitors the monitored device 14. Specifically, the monitoring server 13 monitors whether a failure occurs in the monitored device 14.

The server 14A is, for example, a server device that provides various kinds of services with a user. Furthermore, the storage media 14B are, for example, storage devices that provide a service stored in the various kinds of information acquired from the user.

Configuration of the Monitoring Server

In the following, the configuration of the monitoring server 13 according to the embodiment will be described. As illustrated in FIG. 10, the monitoring server 13 includes a communication unit 31, a storing unit 32, and a control unit 33. Furthermore, in addition to the functioning units illustrated in FIG. 10, the monitoring server 13 may also various kinds of functioning units included in a known computer. For example, the monitoring server 13 may also include a displaying unit that displays various kinds of information or an input unit to which various kinds of information is input.

The communication unit 31 is implemented by, for example, a network interface card (NIC). The communication unit 31 is connected to, for example, the network 12 in a wired or a wireless manner. Then, the communication unit 31 sends and receives information to and from the management center 10 or the other data centers 11 via the network 12. Furthermore, the communication unit 31 sends and receives information to and from the monitored device 14 via, for example, the network inside the data center 11.

The storing unit 32 is a storage device that stores therein various kinds of data. For example, the storing unit 32 is a storage device, such as a hard disk, a solid state drive (SSD), an optical disk, or the like. Furthermore, the storing unit 32 may also be a semiconductor memory, such as a random access memory (RAM), a flash memory, a nonvolatile static random access memory (NVSRAM), or the like, that can rewrite data.

The storing unit 32 stores therein Operating Systems (OSs) or various kinds of programs that are executed in the control unit 33. For example, the storing unit 32 stores therein various kinds of programs including a program that executes a migration control process, which will be described later. Furthermore, the storing unit 32 stores therein various kinds of data that are used by the program executed by the control unit 33. For example, the storing unit 32 stores therein setting information 40.

The setting information 40 is data that stores therein defined values needed for each process. For example, the setting information 40 stores therein information related to the data centers, such as the file name of a device log, the file name of a monitoring log, a script name or the like that is used to collect device logs and vendor information, the script name or the like that is used to collect monitoring logs.

FIG. 11 is a schematic diagram illustrating the data structure of the setting information. As illustrated in FIG. 11, the setting information 40 has items of the “file name of a device log”, the “file name of a monitoring log”, the “script name, etc. used to collect device logs and vendor information”, and the “script name, etc. used to collect monitoring logs”. Furthermore, the setting information 40 has an items of the “information about a data center” and the like.

The item of the file name of a device log is an area that stores therein the file name of the device log of the monitored device 14 in which a failure occurs. The item of the file name of a monitoring log is an area that stores therein the file name of a monitoring log of the monitoring server 13. The script name, etc. that is used to collect the device logs and vendor information is an area that stores therein the script name that is used to collect the device logs and the vendor information or is an area that stores therein the command name. The script name, etc. that is used to collect the monitoring logs is an area that stores therein the script name that is used to collect the monitoring logs or is an area that stores therein the command name. The information related to the data center is an area that stores therein various kinds of information related to the data center, such as the name of a system administrator, the contact address, the name of a data center, area information, and the like.

The example illustrated in FIG. 11 indicates that the file name of the device log is “log.tar.gz” and the file name of the monitoring log is “monitor.tar.gz”. Furthermore, the example illustrated in FIG. 11 indicates that the script name, etc. that is used to collect the device logs and the vendor information is “SP11” and the script name, etc. that is used to collect the monitoring logs is “SP12”. Furthermore, the example illustrated in FIG. 11 indicates that the information related to the data center is the “area A”.

A description will be given here by referring back to FIG. 10. The control unit 33 is a device that controls the monitoring server 13. As the control unit 33, an electronic circuit, such as a central processing unit (CPU), a micro processing unit (MPU), and the like, or an integrated circuit, such as an application specific integrated circuit (ASIC), a field programmable gate array (FPGA), and the like, may be used. The control unit 33 includes an internal memory that stores therein control data and programs in which various kinds of procedures are prescribed, whereby various kinds of processes are executed. The control unit 33 functions as various kinds of processing unit by various kinds of programs being operated. For example, the control unit 33 includes a detecting unit 50, a transmitting unit 51, and a receiving unit 52.

The detecting unit 50 detects a failure that occurs in the monitored device 14 or the like operated in the data center 11. For example, the detecting unit 50 detects the operational status of the data center 11. For example, the detecting unit 50 detects, as the operational status of the data center 11, the operational status of the failure in the operational status checking system that is operating in the data center 11. For example, the detecting unit 50 detects whether a failure occurs by using a log or a thermal error of the basic input output system (BIOS) of the monitoring server 13 in which the operational status checking system is operated, by using an event log of the OS of a virtual machine, by using a monitoring ALARM message, or the like.

If a failure occurs in the data center 11, the transmitting unit 51 sends the information related to the failure that has occurred to the management center 10. For example, if a failure occurs in the data center 11, the transmitting unit 51 sends, to the management center 10, the device log of the monitored device 14 in which the failure has occurred, the monitoring log of the monitoring server 13, or the like.

The receiving unit 52 receives various kinds of information sent from the management center 10. For example, if a failure occurs in the data center 11, the receiving unit 52 receives information related to the engineer who handles the failure from the management center 10.

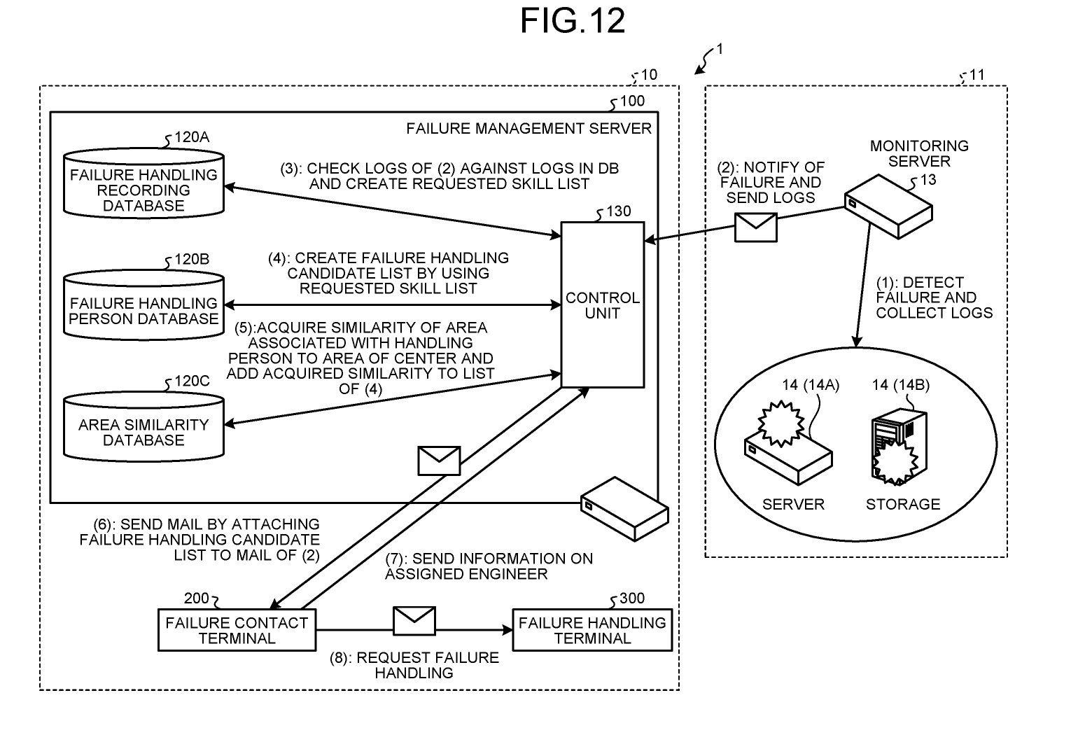

Here, an example of specifying an engineer who handles a failure when the failure has occurred in the data center 11 in the data center system 1 will be described with reference to FIG. 12. FIG. 12 is a schematic diagram illustrating the flow of a process of specifying an engineer who handles a failure handling.

First, if the monitoring server 13 in the data center 11 detects a failure in the monitored device 14, such as the server 14A or the storage media 14B, the monitoring server 13 collects logs (see (1) illustrated in FIG. 12). For example, the monitoring server 13 collects device logs from the monitored device 14. Then, the monitoring server 13 notifies the failure management server 100 in the management center 10 of the failure and sends a mail that includes therein the information related to the logs (see (2) illustrated in FIG. 12). For example, the monitoring server 13 send, to the failure management server 100, a mail that includes therein the information related to the monitoring log of the monitoring server 13 and the device logs collected from the monitored device 14, whereby the monitoring server 13 notifies the failure management server 100 of the occurrence of the failure.

The failure management server 100 that received the notification of the occurrence of the failure checks the logs received from the monitoring server 13 against the logs stored in the failure handling recording database 120A and creates a requested skill list (see (3) illustrated in FIG. 12). Furthermore, the requested skill list is information related to the skills needed to handle the failure that has occurred, which will be described in detail later.

Thereafter, the failure management server 100 creates a failure handling candidate list by using the requested skill list and information related to the engineers stored in the failure handling person database 120B (see (4) illustrated in FIG. 12). Then, the failure management server 100 acquires, from the area similarity database 120C, the similarity of the area that is associated with the engineer who handles the failure and the area that is located in the data center 11 in which the failure has occurred and then add the similarity to the failure handling candidate list (see (5) illustrated in FIG. 12). Furthermore, the failure management server 100 may also specify, on the basis of the similarity of the area, the engineer listed in the failure handling candidate list.

Thereafter, the failure management server 100 attaches the failure handling candidate list to the mail received from the monitoring server and sends the mail to the failure contact terminal 200 (see (6) in FIG. 12). The failure contact terminal 200 sends, to the failure management server 100, the information on the engineer to whom the failure handling is assigned (see (7) in FIG. 12). For example, the contact person who uses the failure contact terminal 200 sends, to the failure management server 100, the information on the engineer to whom the failure handling is assigned from the failure handling candidate list. Then, the failure contact terminal 200 sends a mail that requests the failure handling to the failure handling terminal 300 (see (8) in FIG. 12). The example described above indicates a case in which the failure contact terminal 200 allocates an engineer for the failure handling from the failure handling candidate list; however, the failure management server 100 may also allocate an engineer for the failure handling. In this case, the failure management server 100 sends, to the failure contact terminal 200, the information on the engineer to whom the failure handling is allocated.

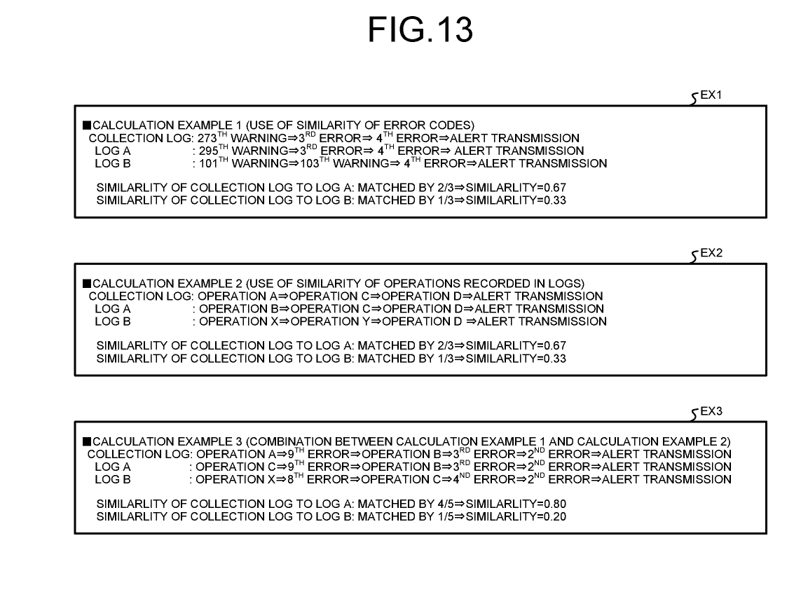

In the following, a calculation of the similarity of logs will be described with reference to FIG. 13. FIG. 13 is a schematic diagram illustrating an example of a calculation of the similarity of logs. FIG. 13 illustrates three examples of the calculations that are calculation examples EX1 to EX3 of the similarity of the logs. First, the calculation example EX1 illustrated in FIG. 13 indicates an example of calculating the similarity of logs by using the resemblance of the error codes included in the logs.

For example, the collection log, which is the log that is collected when a failure has occurred, indicates that three error codes are output in the order of a 273th warning, a third error, and a fourth error and indicates that an alert is sent. In contrast, for example, a log A in the log information 122 stored in the failure handling recording database 120A indicates that three error codes are output in the order of a 295^{th} warning, the third error, and the fourth error and indicates that an alert is sent. Accordingly, in the collection log and the log A, the error code that is output second is the same third error and the error code that is output third is the same fourth error. Here, in the embodiment, the failure management server 100 uses the value obtained by dividing the number of the same error codes by the number of all of the error codes as the similarity. Accordingly, the similarity of the collection log to the log A is ⅔=0.67.

In contrast, for example, a log B in the log information 122 stored in the failure handling recording database 120A indicates that three error codes are output in the order of a 101^{th} warning, a 103^{th} warning, the fourth error and indicates that an alert is sent. Accordingly, in the collection log and the log B, the error code that is output third is the fourth error, which is the same in the both logs. Accordingly, the similarity of the collection log to the log B is ⅓=0.33.

Furthermore, the calculation example EX2 illustrated in FIG. 13 indicates an example of calculating the similarity of the logs by using the resemblance of the operations stored in the logs.

For example, the collection log indicates that an alert is sent after three operations are performed in the order of an operation A, an operation C, and an operation D. In contrast, for example, the log A in the log information 122 stored in the failure handling recording database 120A indicates that an alert is sent after three operations are performed in the order of an operation B, the operation C, and the operation D. Accordingly, in the collection log and the log A, the operation that is performed second is the same operation C and the operation that is performed third is the same operation D. Here, in the embodiment, the failure management server 100 uses the value obtained by dividing the number of the same operations by the number of all of the operations as the similarity. Accordingly, the similarity of the collection log to the log A is ⅔=0.67.

In contrast, for example, the log B in the log information 122 stored in the failure handling recording database 120A indicates that an alert is sent after three operations are performed in the order of an operation X, an operation Y, and an operation D. Accordingly, in the collection log and the log B, the operation that is performed third is the same operation D. Accordingly, the similarity of the collection log to the log B is ⅓=0.33.

Furthermore, the calculation example EX3 illustrated in FIG. 13 indicates an example of calculating the similarity of the logs by using the resemblance of the error codes included in the logs and the resemblance of the operations stored in the logs. As illustrated in FIG. 13, the calculation example EX3 calculates the similarity of the logs by combining the calculation example EX1 and the calculation example EX2. The calculation of the similarity of the logs described above is an example and the failure management server 100 may also calculate the similarity of the logs on the basis of various technologies.

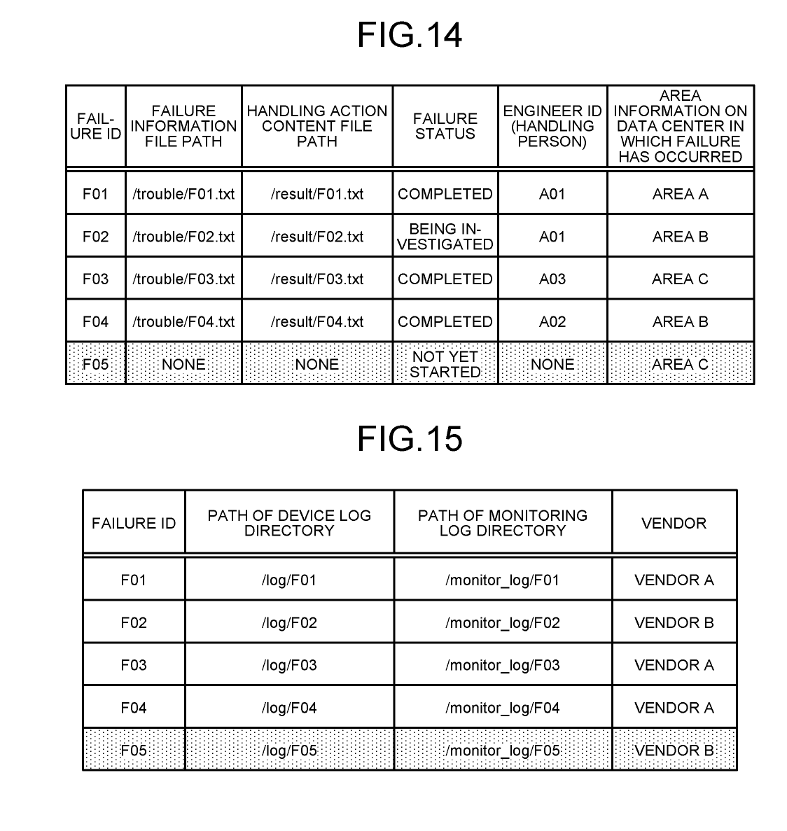

In the following, information that is updated at the time of a process of specifying an engineer (failure handling candidate) who performs failure handling will be described with reference to FIGS. 14 to 17. In FIGS. 14 to 17, a case in which a failure occurs in the data center 11 located in the area C is illustrated as an example.

First, when the failure management server 100 receives a notification of the occurrence of a failure, the failure management server 100 adds, to the failure information 121, the information related to the failure that has occurred. This point will be described with reference to FIG. 14. FIG. 14 is a schematic diagram illustrating an example of the data structure of failure information when new data is added. In the example illustrated in FIG. 14, if the failure management server 100 receives a notification of the occurrence of a failure, the failure management server 100 allocates a new failure ID “F05” to the failure that has occurred and adds, to the failure information 121, information related to the failure that has occurred. In the example illustrated in FIG. 14, the failure with the failure ID “F05” is registered while the failure information file path, the handling action content file path, and the engineer ID are unregistered. Furthermore, in the failure with the failure ID “F05”, information indicating that the failure status has not yet been started and indicate that the area in which the data center 11 in which the failure has occurred is located is the area C.

Furthermore, in addition to adding the information to the failure information 121, the failure management server 100 adds, to the log information 122, the information related to the failure that has occurred. This point will be described with reference to FIG. 15. FIG. 15 is a schematic diagram illustrating an example of the data structure of log information when new data is added. In the example illustrated in FIG. 15, the failure management server 100 adds, to the log information 122, the information related to the failure to which the failure ID “F05” is allocated. In the example illustrated in FIG. 15, for the failure to which “F05” is allocated, information indicating that the device log is stored in “/log/F05” and the monitoring log is stored in “/monitor_log/F05” is stored in the log information 122. Furthermore, information indicating that the vendor of the device in which the failure to which “F05” is allocated has occurred is a vendor B is stored in the log information 122.

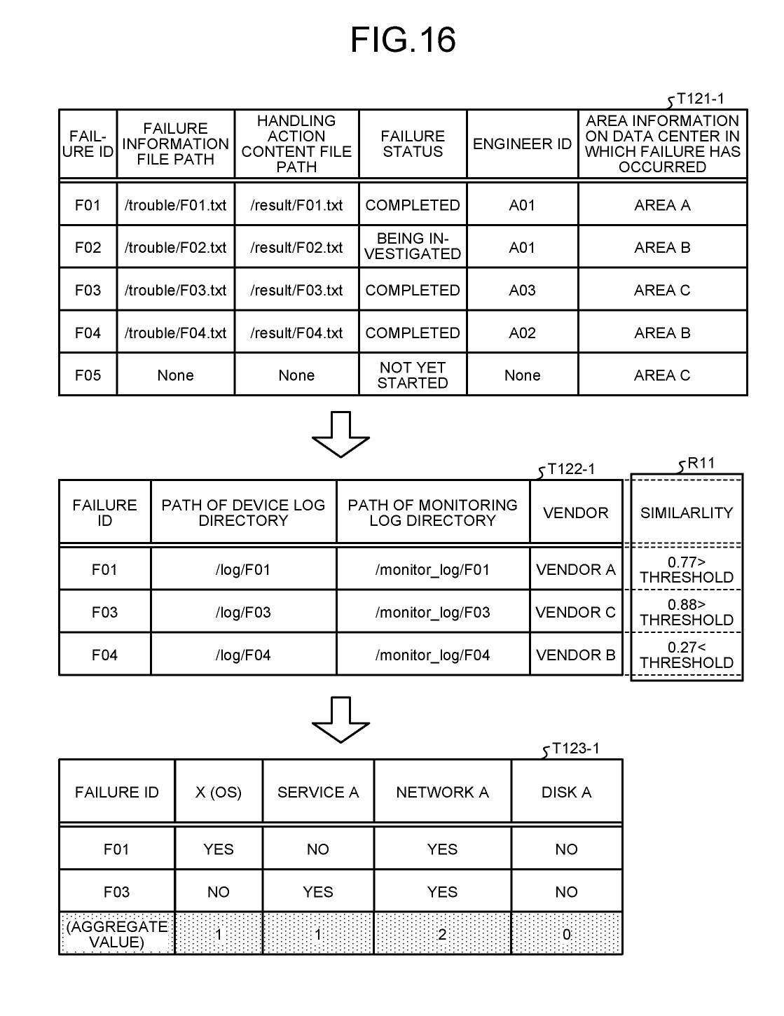

In the following, a process of creating a requested skill list by the failure management server 100 will be described with reference to FIG. 16. FIG. 16 is a schematic diagram illustrating an example of the flow of a process of creating a requested skill list. For example, when the failure management server 100 creates a requested skill list, the failure management server 100 uses the failure information 121, the log information 122, and the requested skill information 123.

In the example illustrated in FIG. 16, failure information T121-1 includes the same information as the failure information 121 that is obtained when new information is added and that is illustrated in FIG. 14. First, the failure management server 100 extracts, from the log information 122, records that are associated with the records in which the failure status has been completed in the failure information T121-1. In the example illustrated in FIG. 16, the records with the failure ID of F01, F03, and F04 are extracted from the log information 122 illustrated in FIG. 15. Then, the failure management server 100 calculates the similarity of each of the logs including the extracted records in the log information T122-1 to the log of the failure that has occurred. In the example illustrated in FIG. 16, as indicated by a similarity R11, the similarity is calculated indicating that the similarity of the failure ID “F01” to the failure that has occurred is 0.77, the similarity of the failure ID “F03” to the subject failure is 0.88, and the similarity of the failure ID “F04” to the subject failure is 0.27. Here, for example, if a threshold is set to 0.5, for the records with the failure ID of F01 and F03, the similarity exceeds the threshold; however, for the record with the failure ID of F04, the similarity is less than the threshold.

Thus, the failure management server 100 extracts the records with the failure ID of F01 and F03 in the requested skill information 123. Furthermore, if the number of extracted records is less than, for example, the threshold TH12 indicated in FIG. 9, the failure management server 100 notifies the failure contact terminal 200 that the number of the extracted record is insufficient to estimate the skill and ends the process. Then, the failure management server 100 creates a requested skill list from the requested skill information T123-1 including the extracted records. In the example illustrated in FIG. 16, a requested skill list in which the aggregate value of the X (OS) is 1, the aggregate value of the service A is 1, the aggregate value of the network A is 1, the aggregate value of the disk A is 0 is created.

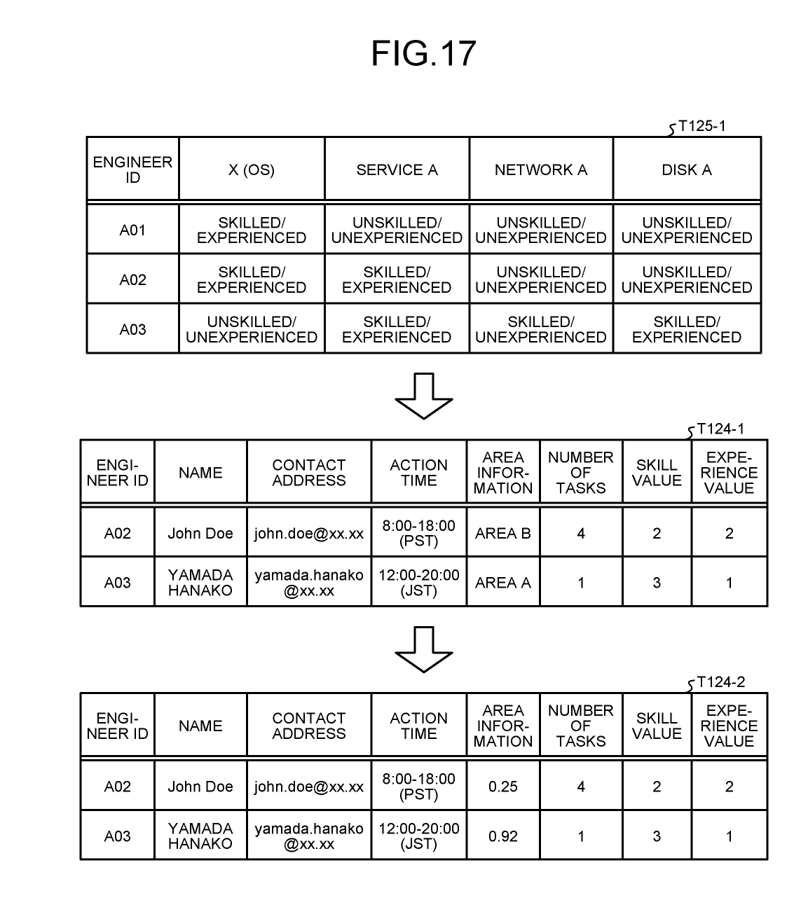

In the following, a process of creating a failure handling candidate list by the failure management server 100 will be described with reference to FIG. 17. FIG. 17 is a schematic diagram illustrating an example of the flow of a process of creating a failure handling candidate list. For example, when the failure management server 100 creates a failure handling candidate list, the failure management server 100 uses the requested skill list, the engineer information 124, and the holding skill information 125 described above.

First, the failure management server 100 calculates a skill value and an experience value of each of the engineers by using the requested skill list and the holding skill information 125. In the example illustrated in FIG. 17, the holding skill information T125-1 includes the same information as the holding skill information 125 illustrated in FIG. 7. Here, when calculating a skill value, the failure management server 100 adds the aggregate value of the requested skill list associated with the item indicated by “skilled” in the holding skill information T125-1. For example, the engineer with the engineer ID “A03” has the skills of the service A, the network A, and the disk A. Thus, the failure management server 100 calculates the skill value of the engineer with the engineer ID “A03” as 3 that is obtained by adding the aggregate value 1 of the service A, the aggregate value 2 of the network A, and the aggregate value 0 of the disk A. Furthermore, the failure management server 100 calculates the skill value of the engineer with the engineer ID “A01” as 1 that is obtained by adding only the aggregate value 1 of the X (OS) and calculates the skill value of the engineer with the engineer ID “A02” as 2 that is obtained by adding the aggregate value 1 of the X (OS) and the aggregate value 1 of the service A.

Furthermore, when the failure management server 100 calculates an experience value, the failure management server 100 adds the aggregate value of the requested skill list associated with the item indicated by “experienced” in the holding skill information T125-1. For example, the engineer with the engineer ID “A02” has an experience of the X (OS) and the service A. Thus, the failure management server 100 calculates the experience value of the engineer with the engineer ID “A02” as 2 that is obtained by adding the aggregate value 1 of the X (OS) and the aggregate value 1 of the service A.

Here, the failure management server 100 extracts engineers with the skill value equal to or greater than a predetermined threshold. In the example illustrated in FIG. 17, the predetermined threshold that is used to determine the skill value is 2 and two engineers, i.e., the engineer with the engineer ID “A02” and the engineer with the engineer ID “A03”, who have the skill value equal to or greater than the threshold 2 are extracted. Furthermore, for the engineer with the engineer ID “A01”, because the skill value is 1 and is less than the threshold 2, the subject engineer is not extracted.

The failure management server 100 extracts the record of the target engineer from the engineer information 124, creates the engineer information T124-1, and adds the skill value and the experience value of each of the engineers. Then, the failure management server 100 creates engineer information T124-2 that is obtained by replacing the area information in the engineer information T124-1 with the similarity between the area associated with each of the engineers and the area in which the data center 11 in which a failure has occurred is located. For example, the area associated with the engineer with the engineer ID “A02” is the area B and the area in which the data center 11 in which the failure has occurred is located in the area C. Thus, the failure management server 100 replaces the area information in the record of the engineer with the engineer ID “A02” with the similarity of “0.25” between the area B and the area C. Furthermore, for example, the area associated with the engineer with the engineer ID “A03” is the area A. Thus, the failure management server 100 replaces the area information in the record of the engineer with the engineer ID “A03” with the similarity of “0.92” between the area A and the area C.

Thereafter, by using the engineer information T124-2 in which the area information is replaced by the similarity, the failure management server 100 classifies the candidates for the failure handling, which will be described in detail later. Furthermore, the failure management server 100 sends a mail to the failure contact terminal 200 on the basis of the engineer information T124-2. For example, the contact person who uses the failure contact terminal 200 determines, on the basis of the information acquired from the failure contact terminal 200, the engineer (failure handling candidate) who performs the failure handling. Furthermore, the failure management server 100 may also determine, on the basis of the engineer information T124-2, the engineer (failure handling candidate) who performs the failure handling. Furthermore, for example, when the failure management server 100 and the contact person who uses the failure contact terminal 200 allow all of the specified failure handling candidates to perform the failure handling, the failure management server 100 and the contact person do not need to perform the determination described above.

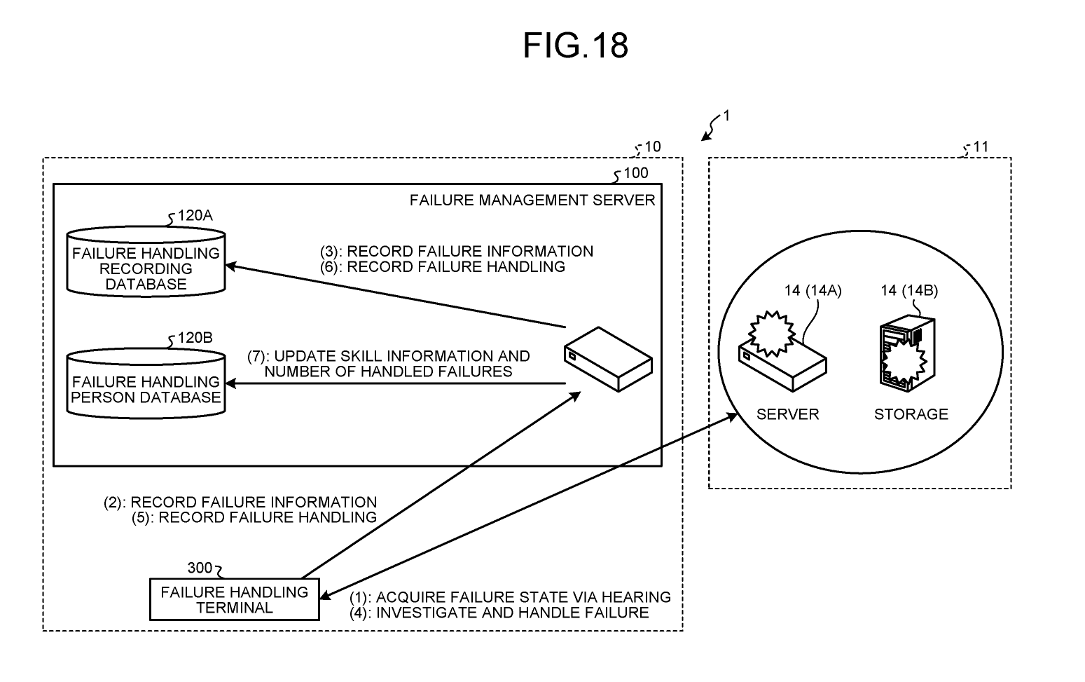

In the following, the flow of a process performed after an engineer who performs the failure handling has been specified will be described with reference to FIG. 18. FIG. 18 is a schematic diagram illustrating an example of the flow of a process performed after an engineer who performs the failure handling has been specified.

First, the failure handling candidate (the failure handling terminal 300) acquires the failure state via a hearing from the data center 11 in which a failure has occurred (see (1) in FIG. 18). Furthermore, the failure handling candidate may also acquire information via a hearing or the like in the data center 11 in which the failure has occurred. Then, the failure handling candidate records the failure information in the failure management server 100 (see (2) in FIG. 18). For example, the failure handling candidate records, in the failure handling recording database 120A, the failure information and the failure ID that is allocated to the failure that has occurred (see (3) in FIG. 18). The failure management server 100 records the failure information recorded by the failure handling candidate in the failure information 121. For example, the failure management server 100 stores therein, as a file, the failure information recorded by the failure handling candidate and registers the path of the saved file in the item of the “failure information file path” in the record that has the failure ID in the failure information 121. Furthermore, the failure management server 100 may also notify the failure handling candidate that the addition has been completed.

Then, on the basis of the information or the like obtained from the logs or the hearing, the failure handling candidate checks and handles the failure that has occurred (see (4) in FIG. 18). Furthermore, the failure management server 100 changes the “failure status” of the record associated with the failure that has occurred from “not yet started” to “being investigated”.

After the failure handling has been completed, the failure handling candidate records the status in the failure management server 100 (see (5) in FIG. 18). For example, the failure handling candidate stores the engineer ID and the failure ID. Furthermore, for example, the failure handling candidate inputs the information on the “failure section” and the “failure content”. The “failure section” may also be selected from the list (hardware failure, operation error, etc.) such that a statistical process of the cause of the failure can be performed later. Furthermore, for example, the failure handling candidate selects the skill information needed for the failure from the skill list. For example, the failure handling candidate may also be selected from the skill list that is created on the basis of the list of the skill item in the requested skill table. Furthermore, for example, if no skill targeted for the skill list is present, the failure handling candidate may also select “other” and input in the text.

Then, the failure management server 100 records the failure handling recorded by the failure handling candidate in the failure handling recording database 120A (see (6) in FIG. 18). Furthermore, the failure management server 100 updates, on the basis of the information recorded by the failure handling candidate, the skill information and the number of the handled failures recorded in the failure handling person database 120B (see (7) in FIG. 18). For example, the failure management server 100 stores the handling action as a file and registers the path of the saved file into the item of the “handling action content file path” of the record that has the failure ID registered in the failure information 121. Furthermore, for example, the failure management server 100 changes the failure status of the record, which is associated with the failure that has occurred, from “being investigated” to “completed”. Furthermore, for example, the failure management server 100 adds a new record to the requested skill information 123 and registers the input failure ID in the item of the failure ID. Furthermore, for example, the failure management server 100 sets the portion of the registered skill item to “Yes” and sets the portion of the unregistered skill item to “No”. Furthermore, for example, the failure management server 100 decrements the number of tasks in the record that is associated with the engineer ID and that is input to the engineer information 124 by one. Furthermore, for example, for the skill information on the record that is associated with the engineer ID and that is input to the holding skill information 125, the failure management server 100 sets the portion of the skill item that is input by the failure handling candidate to “experienced”. Then, the failure management server 100 notifies the failure handling candidate that the registration has been completed.

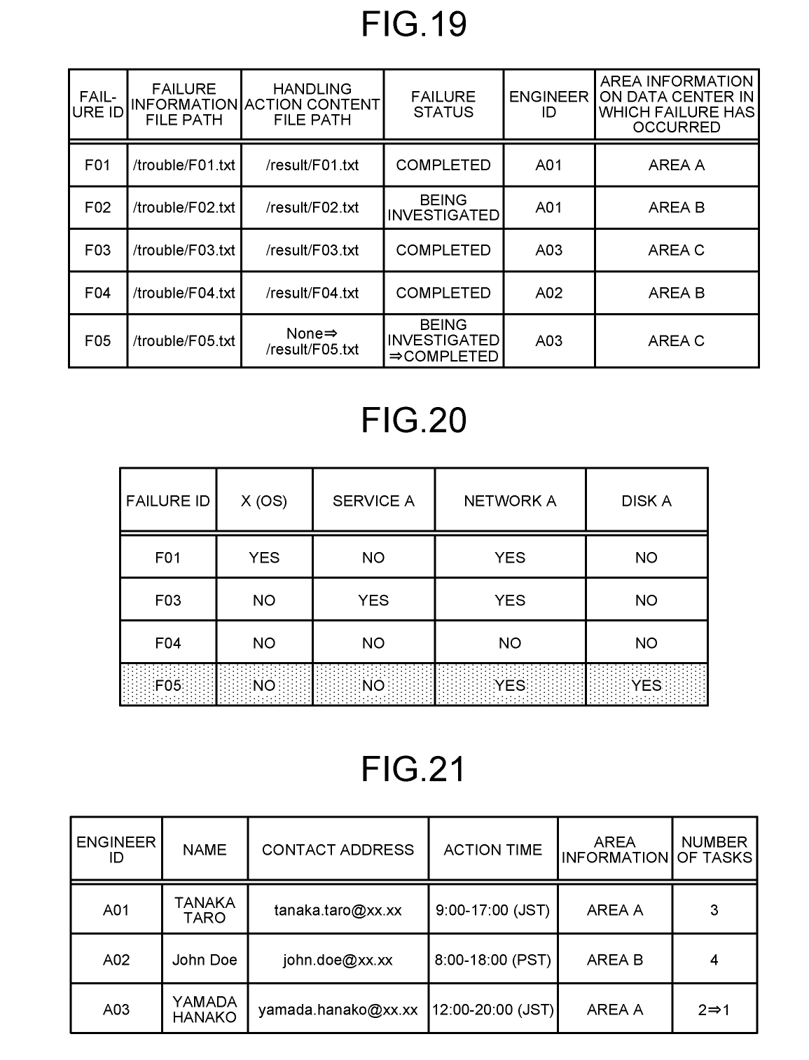

In the following, the information that is updated after the failure handling has been completed will be described with reference to FIGS. 19 to 22. In FIGS. 19 to 22, similarly to the example illustrated in FIGS. 14 to 17, a case in which the failure ID “F05” is allocated to the failure that has been occurred in the data center 11 located in the area C is illustrated as an example. Furthermore, a description will be given below with the assumption that, for the handling of the failure with the failure ID “F05”, two skills, i.e., the skill of the network A and the skill of the disk A, are requested and the engineer with the engineer ID “A03” is specified as the failure handling candidate.

First, if the failure handling has been completed, the failure management server 100 updates the information, in the failure information 121, that is related to the record associated with the failure that has been handled. This point will be described with reference to FIG. 19. FIG. 19 is a schematic diagram illustrating an example of the data structure of the failure information after the failure handling has been completed. In the example illustrated in FIG. 19, the failure management server 100 updates the handling action content file path and the failure status of the record with the failure ID “F05” in the failure information 121. Specifically, in the example illustrated in FIG. 19, the handling action content file path of the record with the failure ID “F05” is updated from “None” to “/result/F05.txt”. Furthermore, in the example illustrated in FIG. 19, the failure status of the record with the failure ID “F05” is updated from “being investigated” to “completed”.

Then, if the failure handling has been completed, the failure management server 100 adds the information on the record associated with the failure that has been handled to the requested skill information 123. This point will be described with reference to FIG. 20. FIG. 20 is a schematic diagram illustrating an example of the data structure of the requested skill information after the failure handling has been completed. In the example illustrated in FIG. 20, the failure management server 100 adds the record with the failure ID “F05” to the requested skill information 123. Specifically, in the example illustrated in FIG. 20, the record that has the failure ID “F05” and in which the request of the two skills of the X (OS) and the service A is “No” and the request of the two skills of the network A and the disk A is “Yes” is added.

Furthermore, if the failure handling has been completed, the failure management server 100 updates the information, in the engineer information 124, on the record that is associated with the failure handling candidate and that has the failure ID “F05”. This point will be described with reference to FIG. 21. FIG. 21 is a schematic diagram illustrating an example of the data structure of the engineer information after the failure handling has been completed. In the example illustrated in FIG. 21, the failure management server 100 updates the number of tasks in the record, in the engineer information 124, that is associated with the engineer who has the engineer ID “A03” and who is the failure handling candidate. Specifically, in the example illustrated in FIG. 21, the number of tasks in the record with the engineer ID “A03” is decremented by one. Namely, in the example illustrated in FIG. 21, the number of tasks in the record with the engineer ID “A03” is updated from “2” to “1”.

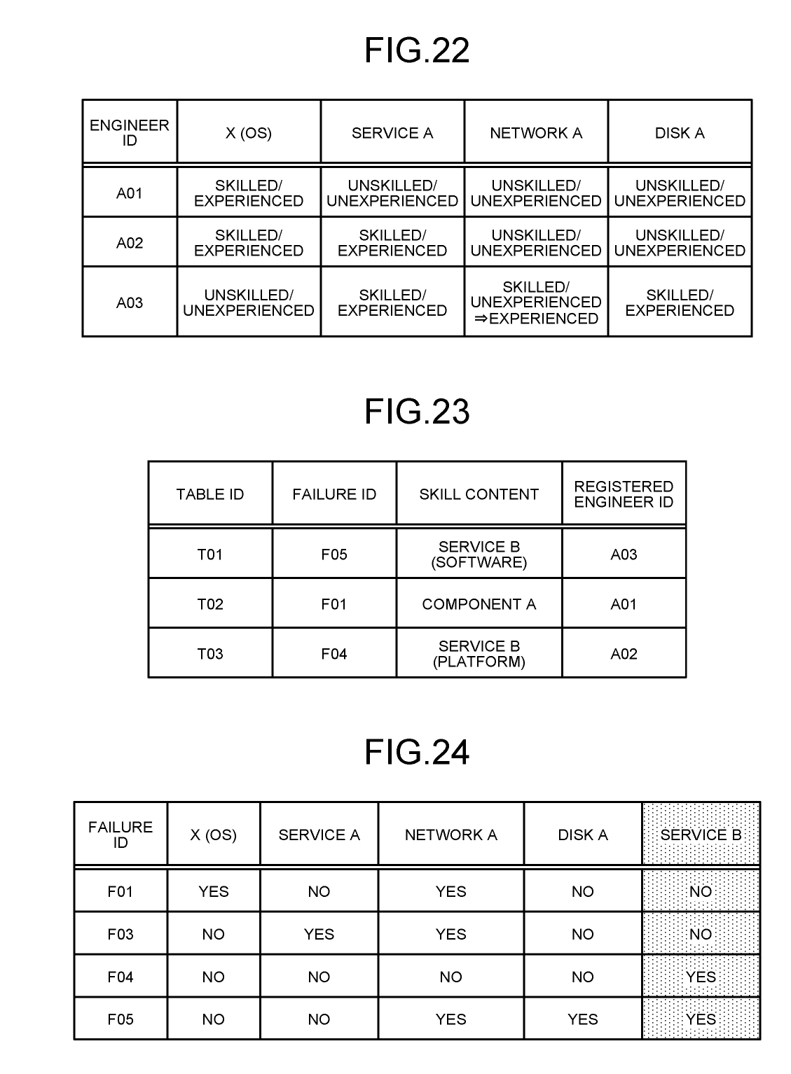

Furthermore, if the failure handling has been completed, the failure management server 100 updates the information on the record, in the holding skill information 125, that is associated with the engineer who has the engineer ID “A03” and who is the failure handling candidate. This point will be described with reference to FIG. 22. FIG. 22 is a schematic diagram illustrating an example of the data structure of the holding skill information after the failure handling has been completed. In the example illustrated in FIG. 22, the failure management server 100 updates the skill and the experience of the record, in the holding skill information 125, that is associated with the engineer who has the engineer ID “A03” and who is the failure handling candidate. Specifically, in the example illustrated in FIG. 22, the skills and the experiences of the network A in the record with the engineer ID “A03” are updated to skilled and experienced. Namely, in the example illustrated in FIG. 22, the network A indicated by “unexperienced” in the record with the engineer ID “A03” updated to “experienced”.

In the following, a case in which an unregistered skill is added to a skill item will be described on the basis of FIGS. 23 to 25.

The unregistered skill information 128 is data that stores therein the information related to unregistered skills that have not been added to the skill item in the requested skill information 123 and the holding skill information 125. For example, if “other” is selected when the failure handling process is recorded, the failure management server 100 registers, in the unregistered skill information 128, the content of the skill that is input in the text, the failure ID thereof, and the engineer ID.

FIG. 23 is a schematic diagram illustrating an example of the data structure of unregistered skill information. As illustrated in FIG. 23, the unregistered skill information 128 has items of the “table ID”, the “failure ID”, the “skill content”, the “registered engineer ID”, and the like.

The table ID is an area that stores therein the identification information that identifies the information related to the unregistered skill that has been registered. A table ID is attached, as the identification information that identifies each of the pieces of the information, to the information related to unregistered skill that has been registered in the unregistered skill information 128. In the item of the table ID, the table ID attached to the information related to the unregistered skill that has been registered is stored. The item of the failure ID is an area that stores therein the identification information that identifies the failure that occurs in the data center system 1. For example, in the item of the failure ID, the failure ID that is input when “other” is selected at the time of recording the failure handling process. The item of the skill content is an area that stores therein the skill content requested when the failure handling process is performed. The item of the registered engineer ID is an area that stores therein the engineer ID of the failure handling candidate. For example, in the item of the registered engineer ID, the engineer ID that is input when “other” is selected at the time of recording the failure handling process.

The example illustrated in FIG. 23 indicates that the information related to the unregistered skill that is identified by the table ID “T01” is the skill that is requested when the failure ID “F05” is handled and indicates that the subject skill content is the “service B (software)”. Furthermore, the example illustrated in FIG. 23 indicates that the information related to the unregistered skill that is identified by the table ID “T01” is registered by the engineer with the engineer ID “A03”.

In the following, a description will be given of an example in which the unregistered skill in the unregistered skill information 128 is added to the skill item in the requested skill information 123 or the holding skill information 125. In below, a description will be given of an example in which the skill content “service B (software)” of T01 and the skill content “service B (platform)” of T03 are integrated to a single skill item of “service B” and the integrated “service B” is added to the requested skill information 123 and the holding skill information 125. In this way, the similar skills in the unregistered skill information 128 may also be added to the requested skill information 123 and the holding skill information 125 as the integrated skill item.

First, the failure management server 100 adds the unregistered skill to the requested skill information 123 as a skill item. This point will be described with reference to FIG. 24. FIG. 24 is a schematic diagram illustrating an example of the data structure of the requested skill information after a skill item is added. In the example illustrated in FIG. 24, the “service B” is added as a new skill item described above. At this time, from among the records in the requested skill information 123, in the record with the failure ID associated with the “service B” in the unregistered skill information 128, a request indicated by “Yes” is set in the “service B”. Specifically, from among the records in the requested skill information 123, for the two records with the failure IDs of “F04” and “F05”, the request indicated by “Yes” is set in the “service B”. Furthermore, from among the records in the requested skill information 123, for the two records with the failure IDs of “F01” and “F03”, a request indicated by “No” is set in the “service B”.

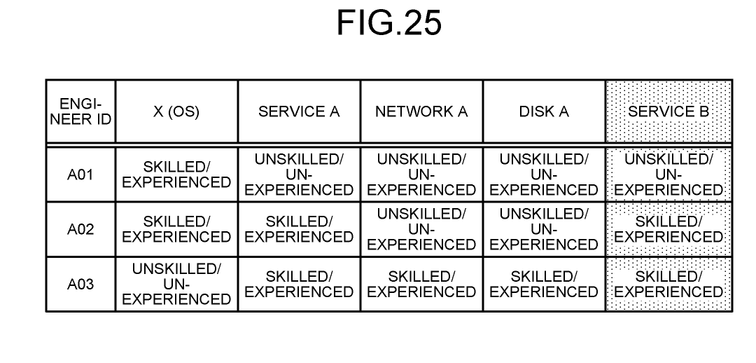

Furthermore, the failure management server 100 adds the unregistered skill to the holding skill information 125 as the skill item. This point will be described with reference to FIG. 25. FIG. 25 is a schematic diagram illustrating an example of the data structure of the holding skill information after the skill item is added. In the example illustrated in FIG. 25, the “service B” is added as the new skill item described above. At this point, from among the records in the holding skill information 125, the record associated with the engineer who registered the “service B” in the unregistered skill information 128 sets the “service B” to “skilled/experienced”. Specifically, from among the records in the holding skill information 125, for the record that is associated with the engineer with the engineer ID “A02” and the record that is associated with the engineer with the engineer ID “A03”, the “service B” is set to “skilled/experienced”. Furthermore, from among the records in the holding skill information 125, for the record associated with the engineer with the engineer ID “A01”, the “service B” is set to “unskilled/unexperienced”.

Furthermore, the failure management server 100 may also update the area similarity information at predetermined intervals (for example, once a week or the like). An example of a process in which the failure management server 100 updates the area similarity information will be described below. For example, the failure management server 100 extracts, from each of the records on the failure information, a record in which the failure status is “completed”. For example, the failure management server 100 performs a statistical process on the basis of the “failure section” of the file indicated by the “handling action content file path” and the “area information on the data center in which the failure has occurred” in the extracted record, and aggregates for each area. For example, the failure section may also be created on the base of the failure caused by a geographical characteristic. In the geographical characteristic mentioned here, various kinds of information, such as a climate, the stability of the electrical power supply, or the like, may also be included. For example, the failure section may also include the climate calculated on the basis of the frequency of the failure caused by a temperature and humidity as the geographical characteristic. Furthermore, for example, the failure section may also include an environment that is calculated on the basis of the frequency of the failure caused by the environment, such as cosmic rays, a hardware failure, or the like. Furthermore, for example, the failure section may also be created on the basis of the failure that occurred in the data center 11 in the past. For example, the failure section may also include the hardware quality or the software quality calculated on the basis of the frequency of, for example, a hardware failure. Furthermore, for example, the failure section may also include the learning level of an operator calculated on the basis of the frequency of the failure caused by, for example, an operation error and a setting error. Furthermore, the failure section may also be divided into parts in accordance with the object. For example, the failure section “climate” may also be divided into a “high-temperature environment failure”, a “low-temperature environment failure”, a “failure caused by the humidity”, and the like. Then, for all of the combinations of the areas, the failure management server 100 calculates the similarity between the areas of the itemized aggregate value acquired from the aggregation for each area and updates the area similarity information to the obtained result.

Flow of the Process Performed in the Data Center System

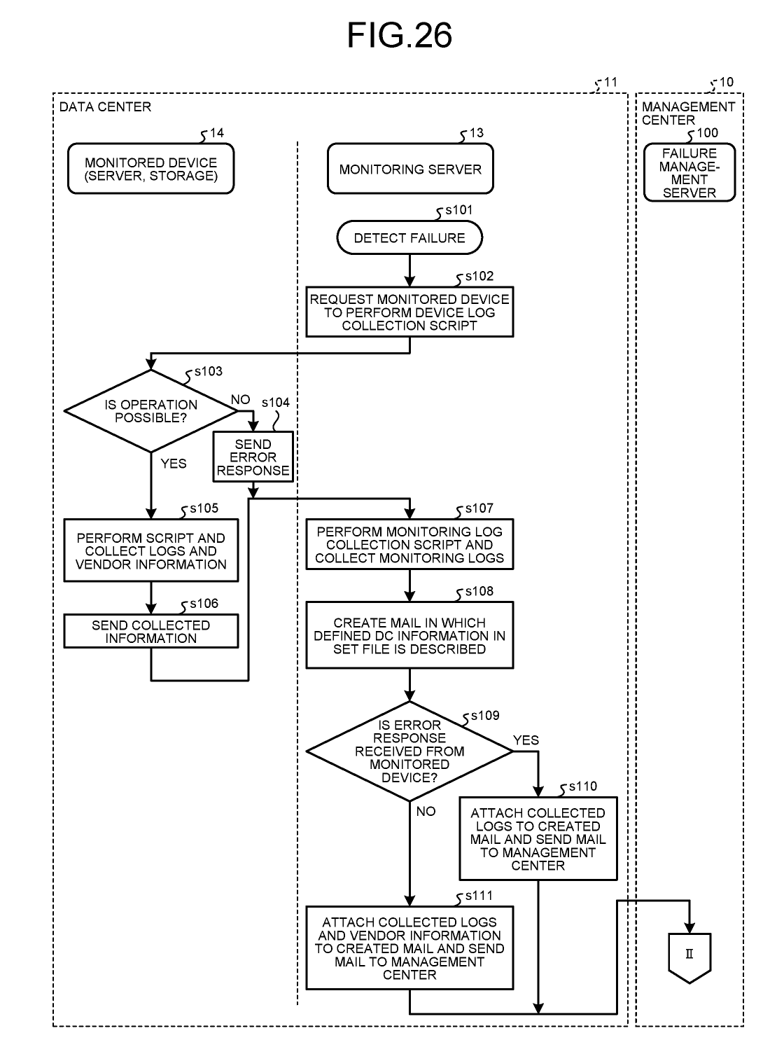

In the following, the flow of the process performed by the data center system 1 according to the embodiment will be described on the basis of FIGS. 26 to 39. First, the process of detecting a failure to the process of specifying a failure handling candidate performed in the data center system 1 will be described on the basis of FIGS. 26 to 33.

FIG. 26 is a schematic diagram illustrating an example of the flow of a process in the data center when a failure is detected. First, the monitoring server 13 detects a failure that has occurred in the data center 11 (Step s101). Then, the monitoring server 13 requests the monitored device 14 in which the failure has occurred to perform a device log collection script (Step s102).

If the operation is not possible (No at Step s103), the monitored device 14 that accepts the request from the monitoring server 13 sends an error response to the monitoring server 13 (Step s104). Furthermore, if the operation is possible (Yes at Step s103), the monitored device 14 performs the script and collects logs and the vendor information (Step s105). Thereafter, the monitored device 14 sends the collected information to the monitoring server 13 (Step s106).

The monitoring server 13 that received the information from the monitored device 14 performs the monitoring log collection script and collects the monitoring logs (Step s107). Then, the monitoring server 13 creates a mail in which DC information that is the information that is related to the data center and that is defined in the set file is described (Step s108).

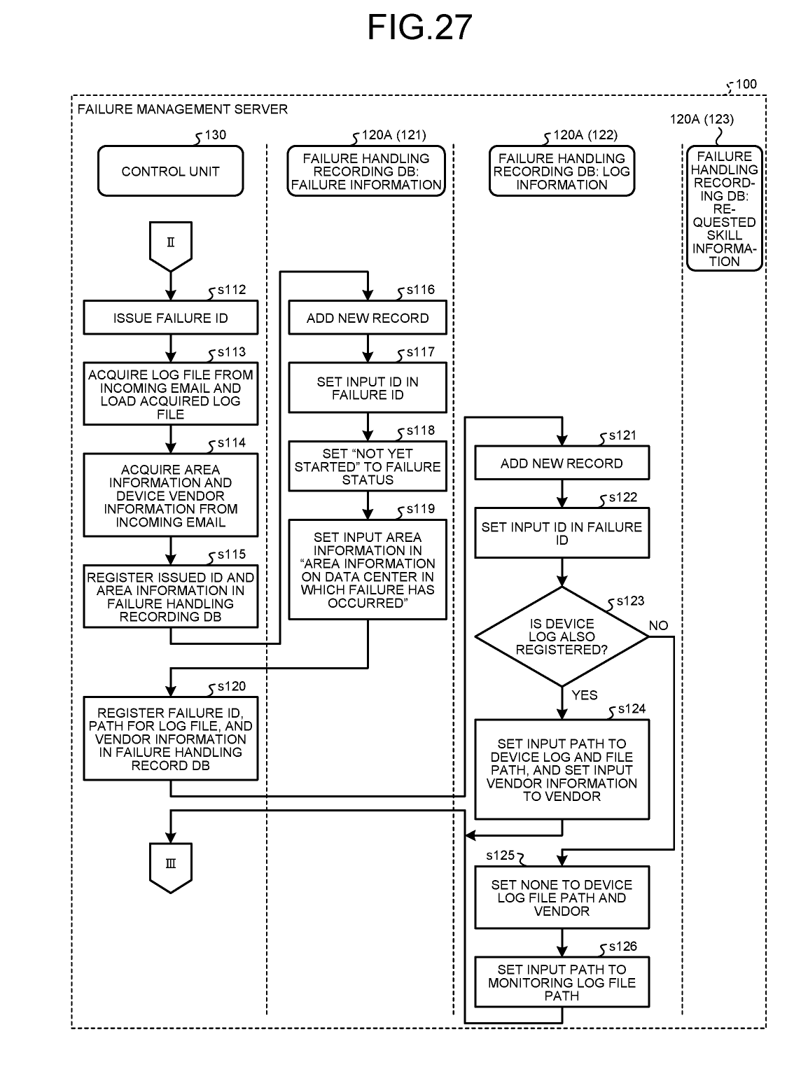

Then, if an error response is received from the monitored device 14 at Step s104 (Yes at Step s109), the monitoring server 13 attaches the collected logs to the created mail and sends the mail to the management center 10 (Step s110). Then, the management center 10 that received the mail performs the process at Step s112 illustrated in FIG. 27. Furthermore, if an error response is not received from the monitored device 14 (No at Step s109), the monitoring server 13 attaches the collected logs and the vendor information to the created mail and sends the mail to the management center 10 (Step s111). Then, the management center 10 that received the mail performs the process at Step s112 illustrated in FIG. 27.

In the following, the process performed on the management center 10 side that received the mail will be described. FIGS. 27 to 29 are schematic diagrams each illustrating an example of the flow of a process in which a failure management server creates a requested skill.

First, the control unit 130 in the management center 10 that received the mail from the monitored device 14 issues a failure ID (Step s112). Then, the control unit 130 acquires a log file from the incoming email and loads the acquired file (Step s113). Furthermore, the control unit 130 acquires the area information and the device vendor information from the incoming email (Step s114). Furthermore, the control unit 130 registers the issued ID (issued failure ID) and the area information in the failure handling recording database 120A (hereinafter, referred to as a failure handling record DB 120A) (Step S115).

The failure handling record DB 120A that received the registration from the control unit 130 adds a new record (Step s116). Then, the failure handling record DB 120A sets the input ID that is the failure ID acquired from the control unit 130 in the failure ID (Step s117). Furthermore, the failure handling record DB 120A sets “not yet started” in the failure status (Step s118). Furthermore, the failure handling record DB 120A sets the input area information in the “area information on the data center in which the failure has occurred” and notifies the control unit 130 of the input area information (Step s119).

The control unit 130 that received the notification from the failure handling record DB 120A registers the failure ID, the path for the log file, and the vendor information in the failure handling record DB 120A (Step s120).

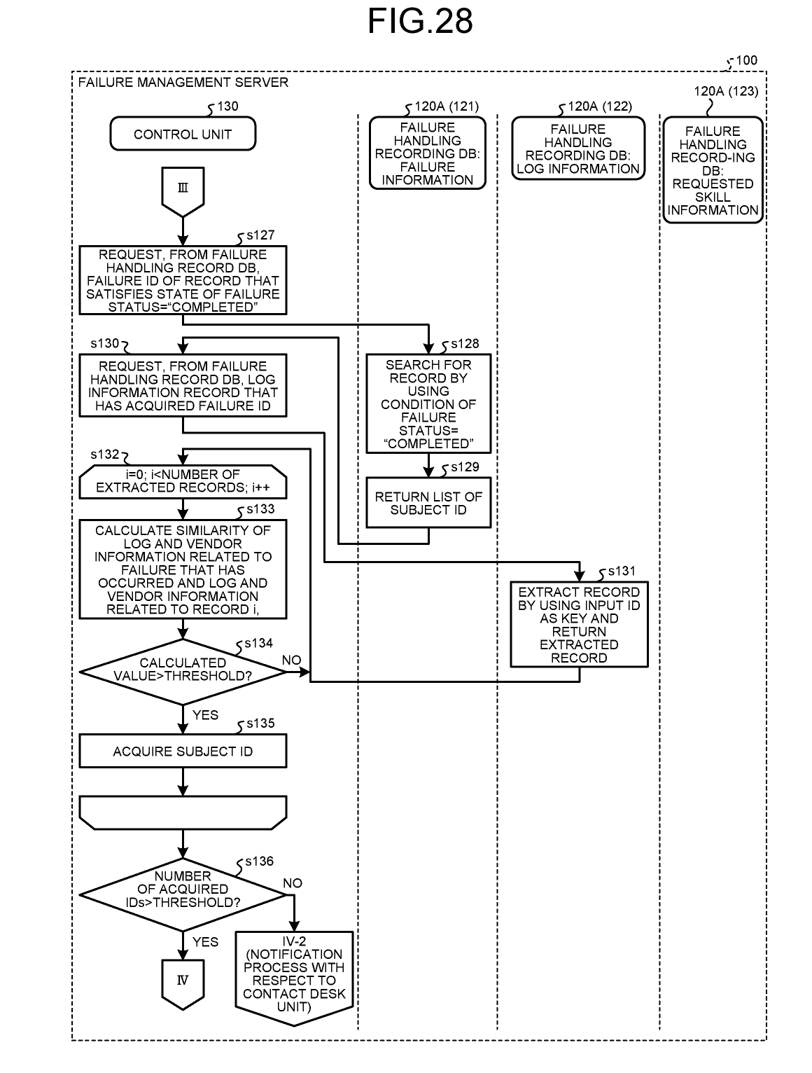

The failure handling record DB 120A that accepted the registration from the control unit 130 adds a new record (Step s121). Then, the failure handling record DB 120A sets the input ID that is the failure ID acquired from the control unit 130 to the failure ID (Step s122). Furthermore, if the device log is also registered (Yes at Step s123), the failure handling record DB 120A sets an input path to the device log and the file path for the monitoring log, sets the input vendor information to the vendor, and notifies the control unit 130 of the result (Step s124). Thereafter, the control unit 130 that received the notification performs the process at Step s127 illustrated in FIG. 28. Furthermore, if the device log is not registered (No at Step s123), the failure handling record DB 120A sets None to the device log file path and the vendor (Step s125). Then, the failure handling record DB 120A sets the input path to the monitoring log file path and notifies the control unit 130 of the result (Step s126). Thereafter, the control unit 130 that received the notification performs the process at Step s127 illustrated in FIG. 28.

As illustrated in FIG. 28, the control unit 130 that received the notification from the failure handling record DB 120A requests, from the failure handling record DB 120A (the failure information 121), the failure ID of the record that satisfies the failure status indicated by “completed” (Step s127). For example, the control unit 130 requests, from the failure handling record DB 120A, the failure ID of the record that satisfies the failure status indicated by “completed” in the failure information 121.

The failure handling record DB 120A that received the request searches the failure information 121 for the record by using the condition that the failure status is “completed” (Step s128). Then, the failure handling record DB 120A returns the list of the subject ID to the control unit 130 (Step s129).

The control unit 130 that acquired the list of the subject ID requests, from the failure handling record DB 120A (the log information 122), the record that has the acquired failure ID (acquired ID) (Step s130).

The failure handling record DB 120A that accepted the request extracts the record from the log information 122 by using the input ID that is the input failure ID as a key and returns the extracted record to the control unit 130 (Step s131).

The control unit 130 that acquired the extracted record from the failure handling record DB 120A sets the variable i to 0, performs the process at Steps s133 to s135, and repeats the process of incrementing the variable i by 1 by the number of times that corresponds to the number of extracted records (Step s132). First, the control unit 130 calculates the similarity of the log and the vendor information related to the failure that has occurred and the log and the vendor information related to the record i (Step s133). For example, by calculating the similarity of the logs illustrated in FIG. 13, the control unit 130 calculates the similarity of the log information. At this time, if the calculated value calculated at Step s133 is greater than a predetermined threshold (Yes at Step s134), the control unit 130 acquires the subject ID (Step s135), returns to Step s132, and repeats the process. Furthermore, if the calculated value calculated at Step s133 is equal to or less than the predetermined threshold (No at Step s134), the control unit 130 returns to Step s132 and repeats the process.

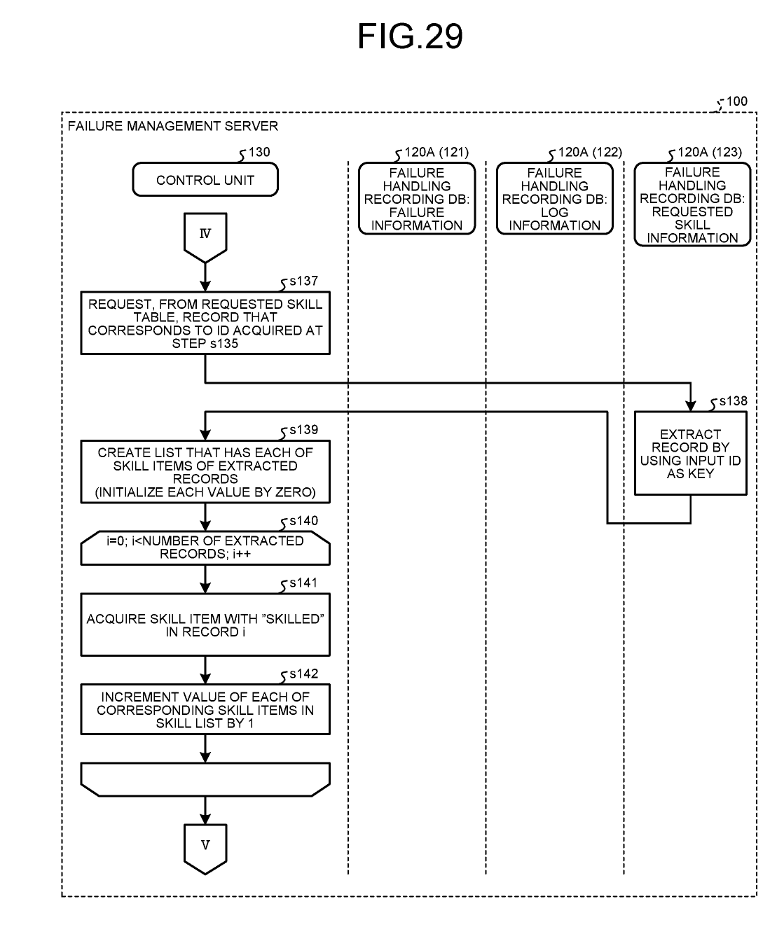

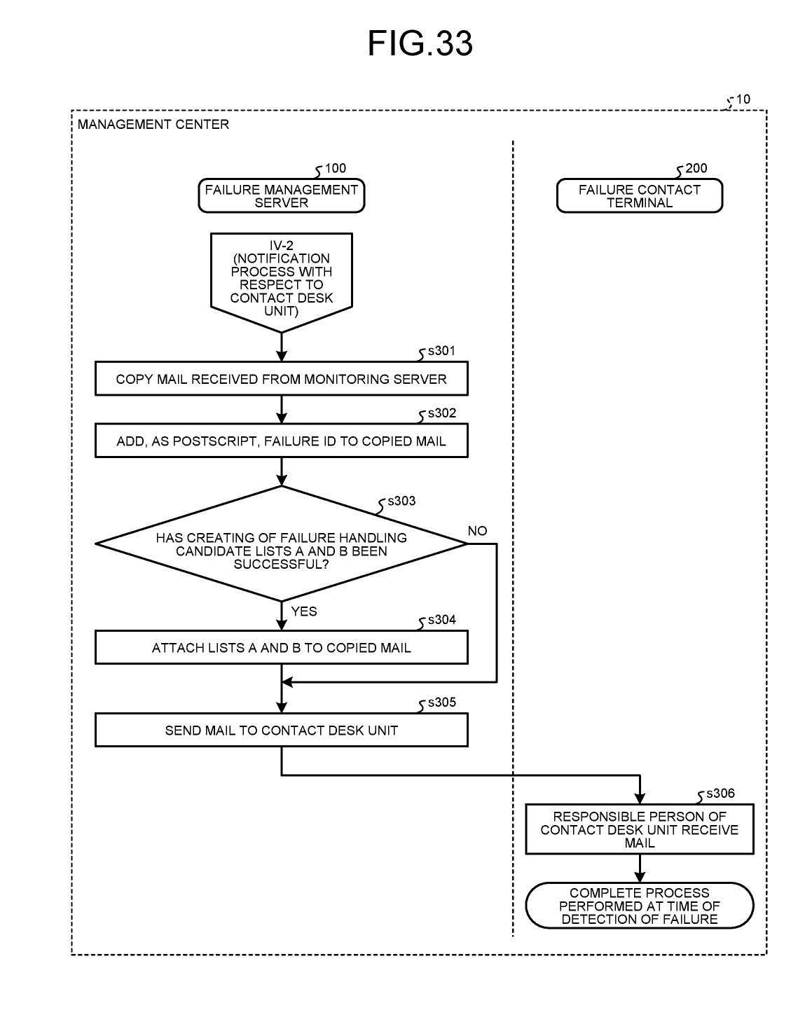

After the control unit 130 ends the processes that are repeatedly performed at Steps s132 to s135, if the number of acquired IDs that are acquired at Step S135 is greater than the predetermined threshold (Yes at Step s136), the control unit 130 performs the process at Step s137 illustrated in FIG. 29. Furthermore, if the number of acquired IDs that are acquired at Step s135 is less than the predetermined threshold (No at Step s136), the control unit 130 performs the process at Step s301 illustrated in FIG. 33.

As illustrated in FIG. 29, if the result obtained at Step s136 is positive, the control unit 130 requests, from the failure handling record DB 120A (the requested skill information 123), the record that corresponds to the ID acquired at Step s135 (Step s137).

The failure handling record DB 120A that accepted the request extracts a record from the requested skill information 123 by using the input ID that is the input failure ID as a key and returns the extracted record to the control unit 130 (Step s138).

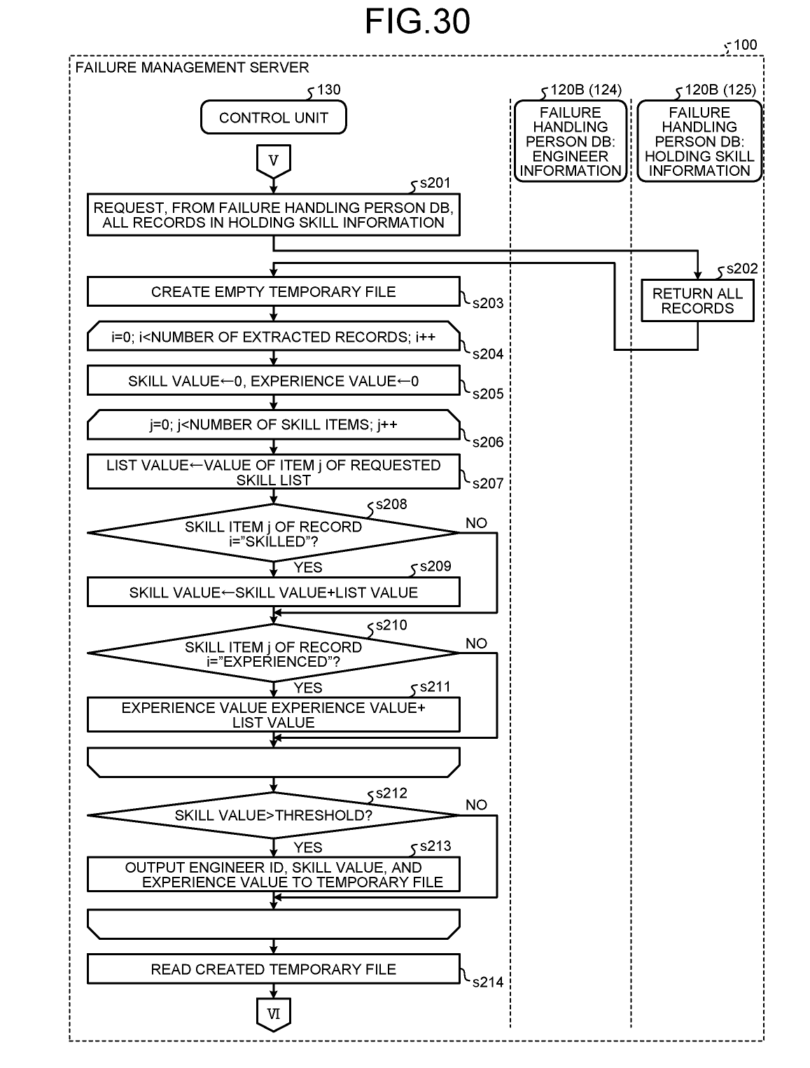

The control unit 130 that acquired the extracted record from the failure handling record DB 120A creates the list that has each of the skill items of the extracted records (Step s139). For example, the control unit 130 may also create, on the basis of the list of the skill item in the requested skill table, a list that has each of the skill items of the extracted records. For example, the control unit 130 may also create a list that has each of the skill items of the record extracted from the requested skill list that is created on the basis of the process illustrated in FIG. 16. For example, the control unit 130 initializes each of the values of the skill item by 0. Then, after the control unit 130 sets the variable i to 0, the control unit 130 performs the processes at Steps s141 and s142 and repeatedly performs the process of incrementing the variable i by 1 by the number of times corresponding to the number of extracted records (Step s140). First, the control unit 130 acquires the skill item indicated by “skilled” in the record i (Step s141). Then, the control unit 130 increments the value of each of the corresponding skill items in the skill list by 1 (Step s142). After the control unit 130 ends the processes repeatedly performed at Steps s140 to s142, the control unit 130 performs the process at Step s201 illustrated in FIG. 30.

Here, FIG. 30 are 32 schematic diagrams each illustrating an example of the flow of a process in which the failure management server creates a failure handling candidate list. After the control unit 130 ends the processes repeatedly performed at Steps s140 to s142, the control unit 130 requests, from the failure handling person database 120B (hereinafter, referred to as a failure handling person DB 120B), all of the records in the holding skill information 125 (Step s201).

The failure handling person DB 120B that accepted the request returns, to the control unit 130, all of the records in the holding skill information 125 as the extracted record (Step s202).

The control unit 130 that acquires the extracted record from the failure handling person DB 120B creates an empty and temporary file (Step s203). Then, after the control unit 130 sets the variable i to 0, the control unit 130 performs the processes at Steps s205 to s213 and repeats the process of incrementing the variable i by 1 by the number of times corresponding to the number of extracted records (Step s204). First, the control unit 130 sets the skill value to 0 and sets the experience value to 0 (Step s205). Then, after the control unit 130 sets the variable j to 0, the control unit 130 performs the processes at Steps s207 to s211 and repeats the process of incrementing the variable j by 1 by the number of times corresponding to the number of extracted records (Step s206). First, the control unit 130 sets the list value to the value of the item j in the requested skill list (Step s207).

Then, if the skill item j of the record i is “skilled” (Yes at Step s208), the control unit 130 updates the skill value to the value obtained by adding the skill value to the list value (Step s209). Thereafter, the control unit 130 performs the process at Step s210. Furthermore, if the skill item j of the record i is not “skilled” (No at Step s208), the control unit 130 performs the process at Step s210.

If the skill item j of the record i is “experienced” (Yes at Step s210), the control unit 130 updates the experience value to the value obtained by adding the experience value to the list value (Step s211). Then, the control unit 130 returns to Step s206 and repeats the processes. Furthermore, if the skill item j of the record i is not “experienced” (No at Step s210), the control unit 130 returns to Step s206 and repeats the processes.

After the control unit 130 ends the processes that are repeatedly performed at Steps s206 to s211, the control unit 130 determines whether the updated skill value is equal to or greater than the predetermined threshold (Step S212). If the updated skill value is equal to or greater than the predetermined threshold (Yes at Step s212), the control unit 130 outputs the engineer ID, the skill value, and the experience value to the temporary file (Step s213). Then, the control unit 130 returns to Step s204 and repeats the processes. Furthermore, if the updated skill value is less than the predetermined threshold (No at Step s212), the control unit 130 returns to Step s204 and repeats the processes.

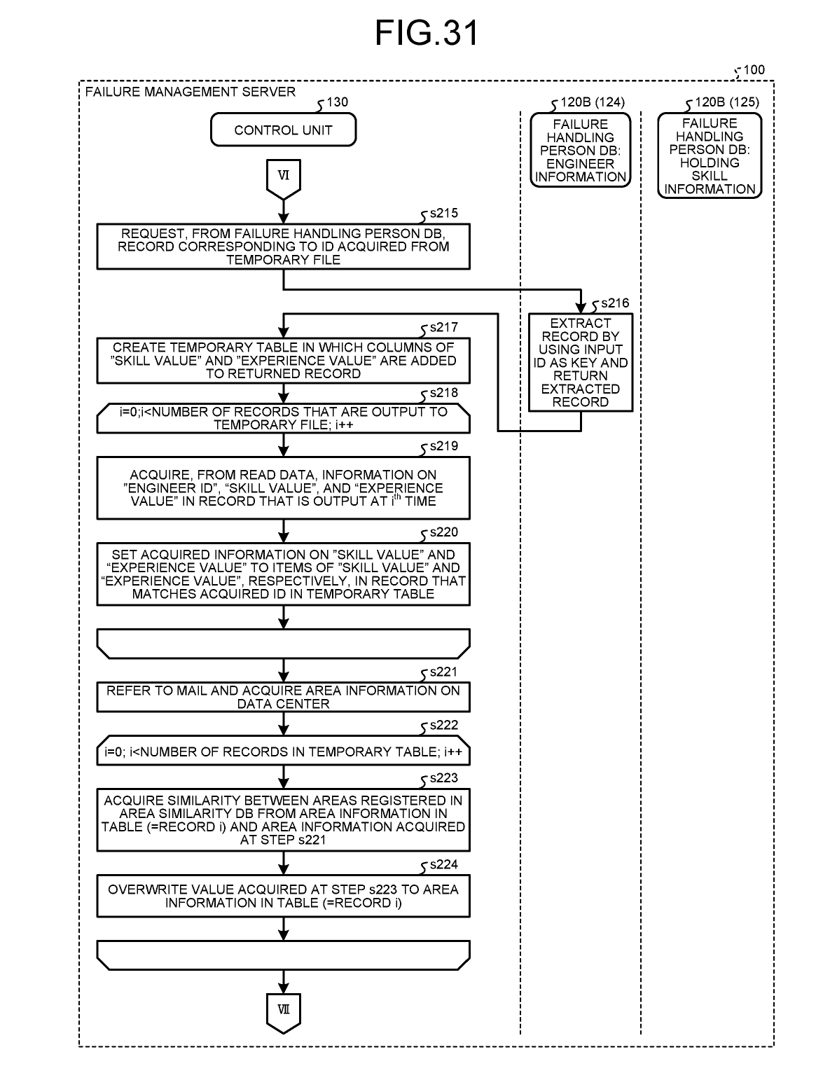

After the control unit 130 ends the processes repeatedly performed at Steps s204 to s213, the control unit 130 reads the created temporary file (Step s214). Then, the control unit 130 performs the process at Step s215 illustrated in FIG. 31.

As illustrated in FIG. 31, the control unit 130 requests, from the failure handling person DB 120B (the engineer information 124), the record corresponding to the ID acquired from the temporary file (Step s215).

The failure handling person DB 120B that accepted the request extracts a record from the engineer information 124 by using, as a key, the input ID that is the ID that was input and then returns the extracted record to the control unit 130 (Step s216).

The control unit 130 that acquired the record from the failure handling person DB 120B creates a temporary table in which the columns of the “skill value” and the “experience value” are added to the returned record (Step s217).

Then, after the control unit 130 sets the variable i to 0, the control unit 130 performs the processes at Steps s219 and s220 and repeats the process of incrementing the variable i by 1 by the number of times corresponding to the number of records that are output to the temporary file (Step s218). First, the control unit 130 acquires, from the read data, the information on the “engineer ID”, the “skill value”, and the “experience value” in the record that is output at the i^{th} time (Step s219). Then, the control unit 130 sets the acquired information on the “skill value” and the “experience value” to the items of the “skill value” and the “experience value”, respectively, in the record that matches the acquired ID in the temporary table (Step s220). Then, the control unit 130 returns to Step s218 and repeats the processes.

After the control unit 130 ends the processes repeatedly performed at Steps s218 to s220, the control unit 130 refers to the mail and acquires the area information on the data center (DC) (Step s221).

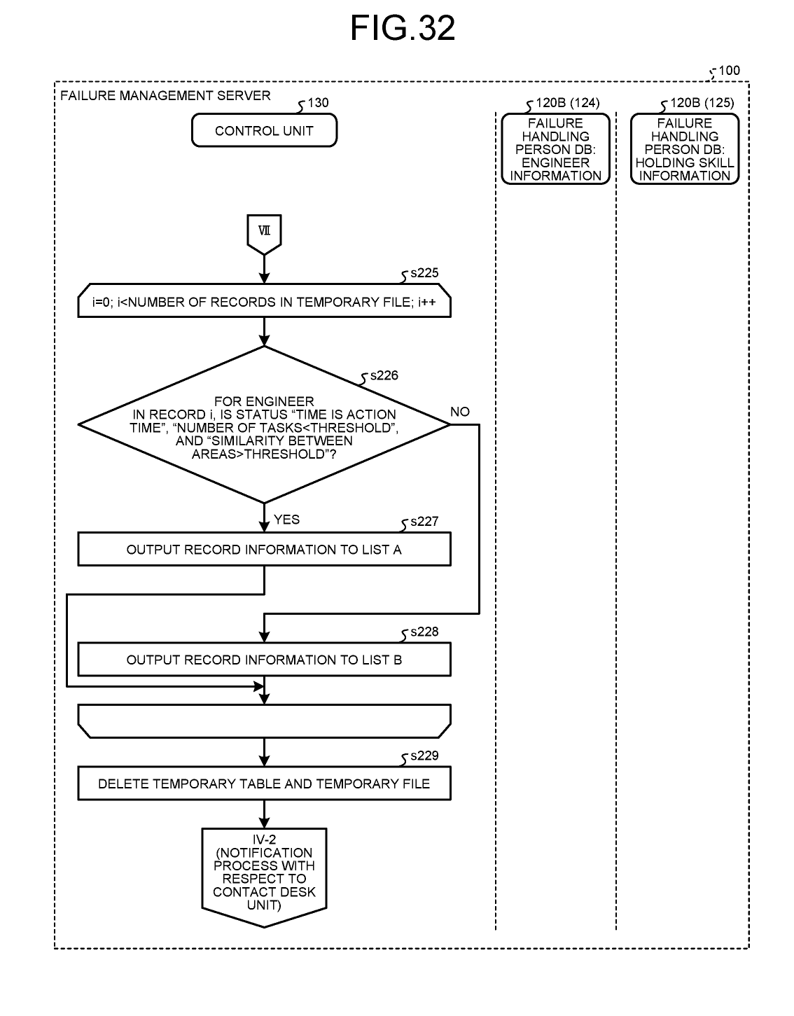

Then, after the control unit 130 sets the variable i to 0, the control unit 130 performs the processes at Steps s223 and s224 and repeats the process of incrementing the variable i by 1 by the number of times corresponding to the number of records in the temporary table (Step s222). First, the control unit 130 acquires the similarity between the areas registered in the area similarity database 120C (hereinafter, referred to as the area similarity DB 120C) from the area information in the table (=record i) and the area information acquired at Step s221 (Step s223). Then, the control unit 130 overwrites the value acquired at Step s223 to the area information in the table (=record i) (Step s224). For example, the control unit 130 may also overwrite the area information on the basis of the area similarity information 126 illustrated in FIG. 8. Thereafter, the control unit 130 returns to Step s222 and repeats the processes. After the control unit 130 ends the processes repeatedly performed at Steps s222 to s224, the control unit 130 performs the process at Step s225 illustrated in FIG. 32.

As illustrated in FIG. 32, after the control unit 130 sets the variable i to 0, the control unit 130 performs the process at Steps s226 to s228 and repeats the process of incrementing the variable i by 1 by the number of times corresponding to the number of record in the temporary table (Step s225). At this point, for the engineer in the record i, if the time is the action time, the number of tasks is less than the predetermined threshold, and the similarity between the areas is greater than the predetermined threshold (Yes at Step s226), the control unit 130 outputs the record information to the list A (Step s227). If the state is other than the above (No at Step s226), the control unit 130 outputs the record information to the list B (Step s228). Then, the control unit 130 returns to Step s225 and repeats the processes. If the control unit 130 ends the processes repeatedly performed at Steps s225 to s228, the control unit 130 deletes the temporary table and the temporary file (Step s229). Then, the failure management server 100 performs the process at Step s301 illustrated in FIG. 33. As described above, the list A created by the control unit 130 becomes the failure handling candidate list. Namely, the control unit 130 specifies the engineer included in the created list A as the failure handling candidate. Namely, the control unit 130 specifies, as a failure handling candidate from among the engineers, the engineer associated, from the process described above, with the area information that is similar to the area information on the data center in which the failure has occurred. Furthermore, the list B created by the control unit 130 may also be used as the failure handling candidate list. In this case, the control unit 130 may also use, for example, the list A as a high recommended failure handling candidate list and the list B as a low recommended failure handling candidate list.

FIG. 33 is a schematic diagram illustrating an example of the flow of a notification process performed with respect to a failure contact desk. First, the failure management server 100 copies the mail received from the monitoring server 13 (Step S301). Then, the failure management server 100 adds, as a postscript, the failure ID to the copied mail (Step s302). If creating of the failure handling candidate lists A and B at Steps s225 to s228 has been successful (Yes at Step s303), the failure management server 100 attaches the lists A and B to the copied mail (Step s304). Then, the failure management server 100 sends the mail to the contact desk unit (the failure contact terminal 200) (Step S305). In contrast, if the creating of the failure handling candidate lists A and B is not successful (No at Step s303), the failure management server 100 sends the mail to the contact desk unit (the failure contact terminal 200) (Step s305). Then, the mail sent from the failure management server 100 is received by the failure contact terminal 200 (Step s306), whereby the process performed when a failure is detected is completed.

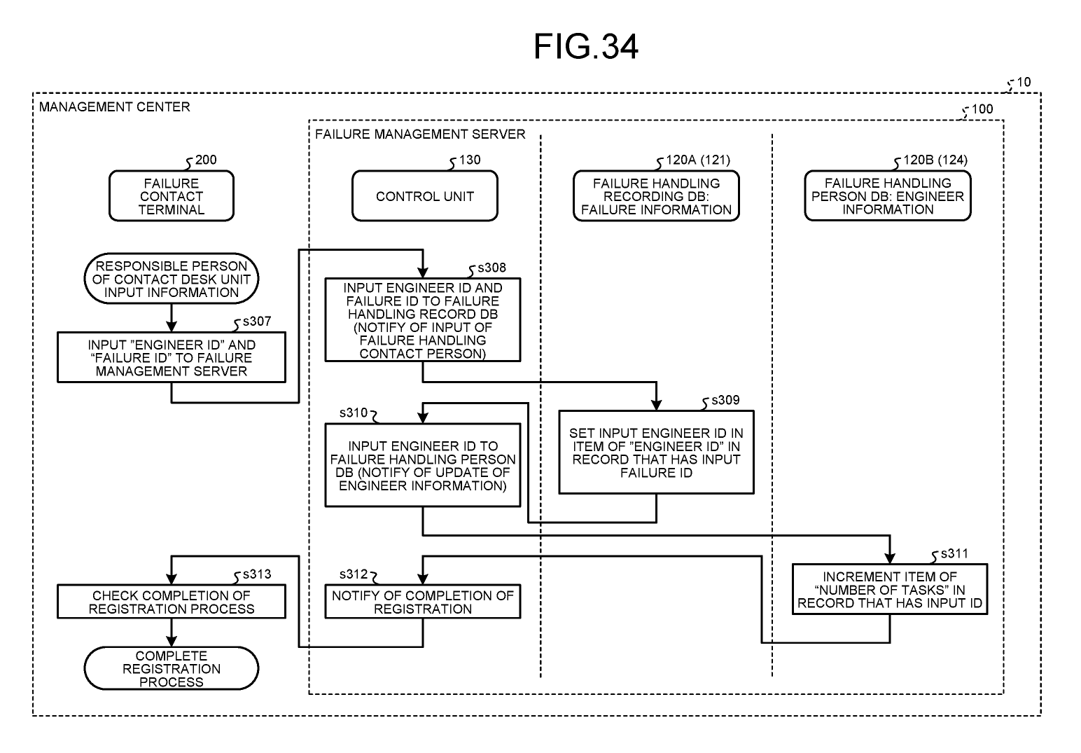

In the following, the process performed after a failure handling candidate is specified will be described with reference to FIGS. 34 to 39. FIG. 34 is a schematic diagram illustrating an example of the flow of a registration process after an engineer who is in charge of a failure has been specified.

First, a responsible person (contact person) at the contact desk inputs, at the failure contact terminal 200, the “engineer ID” and the “failure ID” to the failure management server 100 (Step s307).

The control unit 130 in the failure management server 100 that received an input from the failure contact terminal 200 inputs the engineer ID and the failure ID to the failure handling record DB 120A (the failure information 121) (Step s308). Furthermore, for example, the control unit 130 notifies of an input of a failure handling candidate.

The failure handling record DB 120A that received the input from the control unit 130 sets the input engineer ID in the item of the “engineer ID” in the record, in the failure information 121, that has the input failure ID and notifies the control unit 130 of the setting (Step s309).

The control unit 130 that received the notification from the failure handling record DB 120A inputs the engineer ID to the failure handling person DB 120B (the engineer information 124) (Step s310). For example, the control unit 130 notifies the failure handling person DB 120B that the engineer information has been updated.

The failure handling person DB 120B that received the input from the control unit 130 increments the item of the “number of tasks” in the record that has the input ID in the engineer information 124 by 1 and notifies the control unit 130 of this state (Step s311).

The control unit 130 that received the notification from the failure handling person DB 120B notifies the failure contact terminal 200 (the failure contact person) of the completion of the registration (Step s312).

The failure contact terminal 200 (the failure contact person) checks the completion of the registration process that is received from the control unit 130 in the failure management server 100 (Step s313), whereby the registration process has been completed.

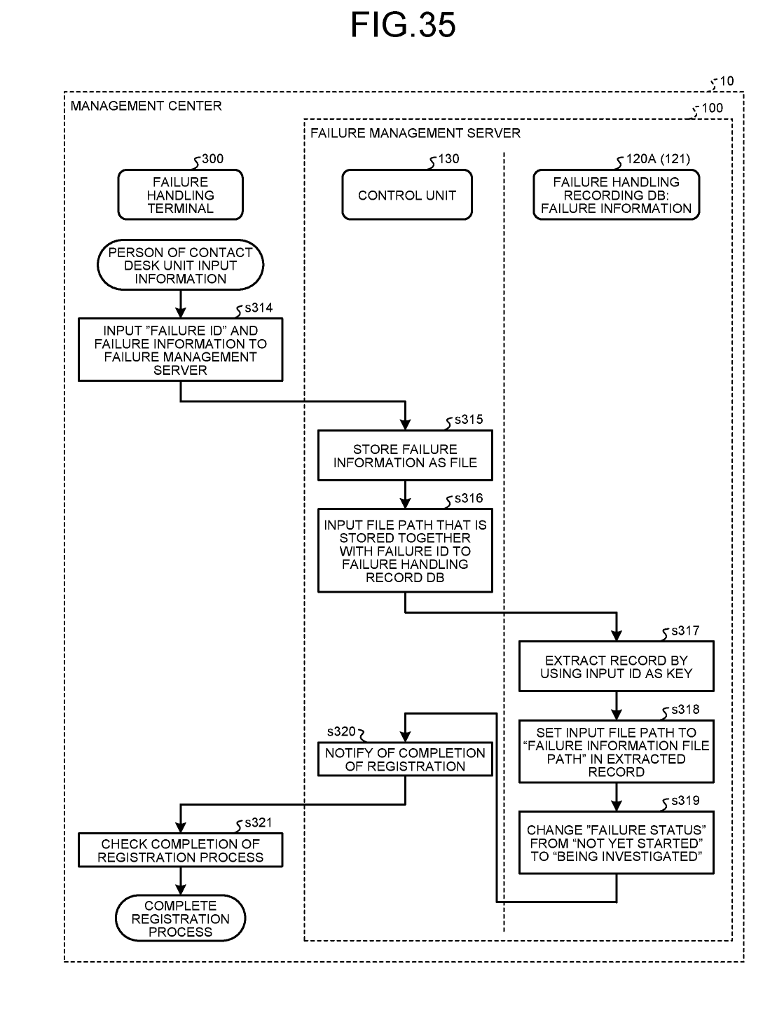

In the following, the registration process performed on the failure information will be described with reference to FIG. 35. FIG. 35 illustrates a schematic diagram illustrating an example of the flow of a of registering the failure information.

First, the failure handling candidate inputs, at the failure handling terminal 300, the “failure ID” and the failure information to the failure management server 100 (Step s314).

The control unit 130 in the failure management server 100 that received an input from the failure handling terminal 300 stores therein the failure information as a file (Step s315). Then, the control unit 130 inputs the file path that is stored together with the failure ID to the failure handling record DB 120A (Step s316).

The failure handling record DB 120A that received the input from the control unit 130 extracts the record from the failure information 121 by using the input ID as a key (Step s317). Then, the failure handling record DB 120A sets the input file path to the “failure information file path” in the extracted record (Step s318). Thereafter, the failure handling record DB 120A changes the “failure status” of the extracted record from “not yet started” to “being investigated” and notifies the control unit 130 of the status (Step s319).

The control unit 130 that received the notification from the failure handling record DB 120A notifies the failure handling terminal 300 (the failure handling candidate) of the completion of the registration (Step s320).

The failure handling terminal 300 (the failure handling candidate) that received from the control unit 130 in the failure management server 100 checks the completion of the registration process (Step s321), whereby the registration process has been completed.

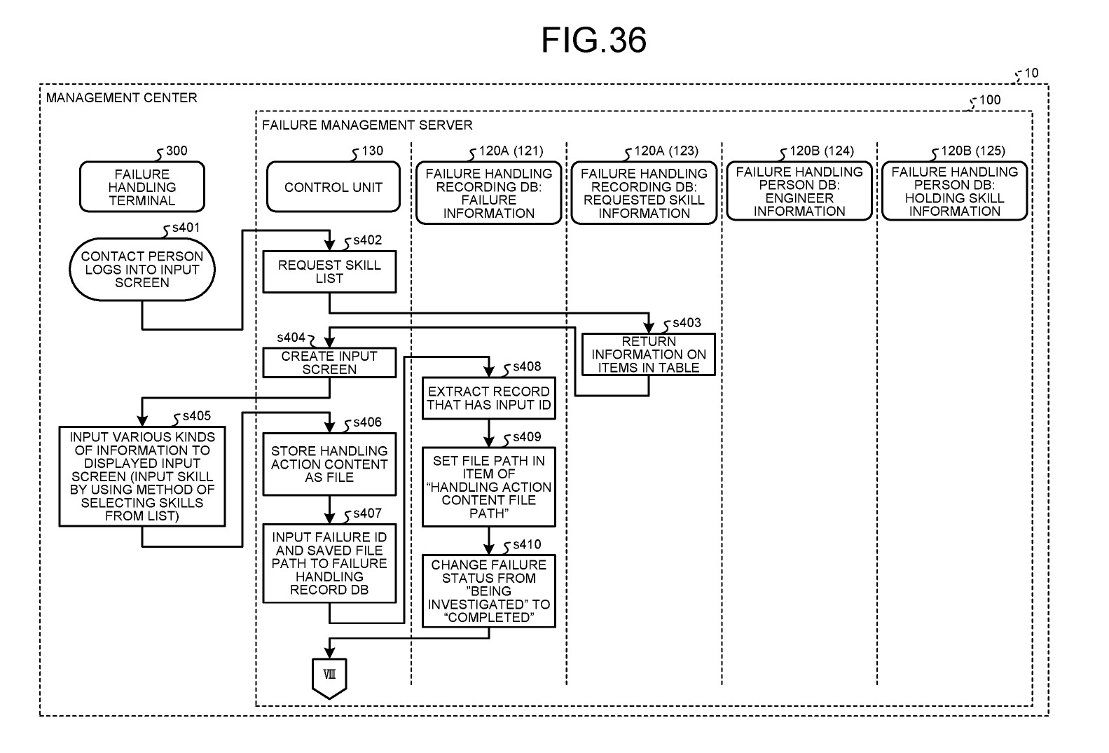

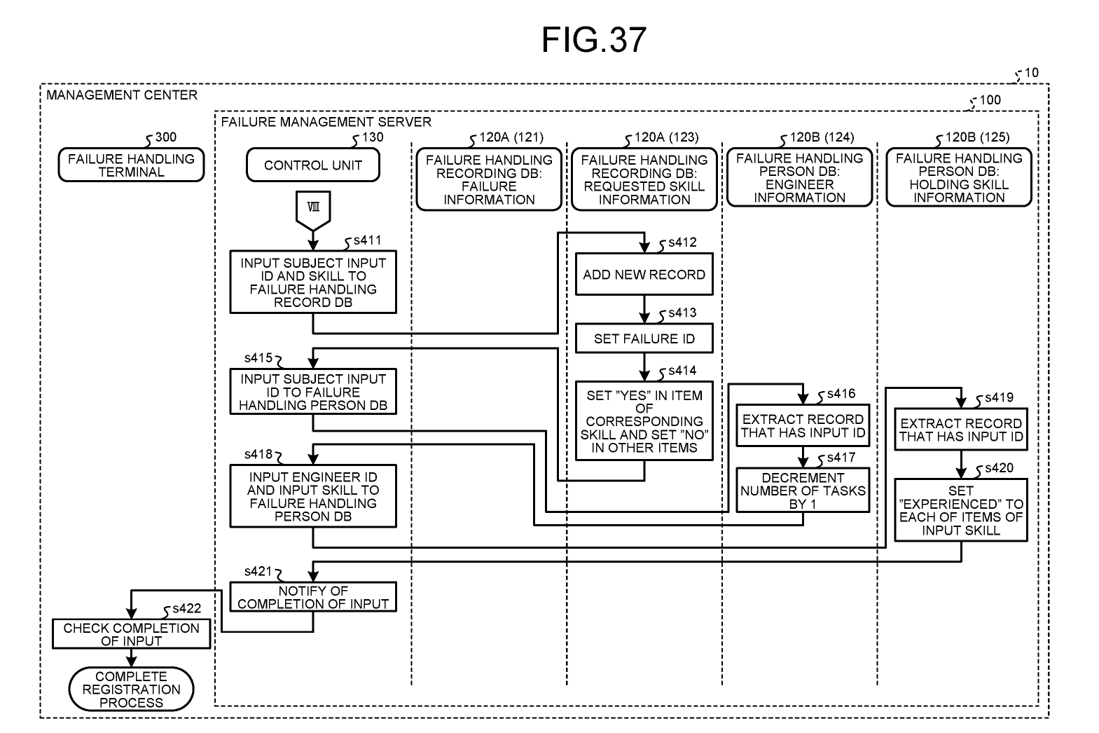

In the following, the registration process performed on the failure information will be described with reference to FIGS. 36 and 37. FIGS. 36 and 37 are schematic diagrams each illustrating an example of the flow of the registration process after the failure handling is performed.

First, a contact person logs into the failure management server 100 by using the input screen at the failure handling terminal 300 (Step s401). At this point, the contact person may also be a failure handling candidate or may also be another contact person who acquired the information requested for the registration from the failure handling candidate.

The control unit 130 in the failure management server 100 in which the contact person logged requests the list of skills from the failure handling record DB 120A (Step s402).

The failure handling record DB 120A that received the request returns the information on the items in the table in the requested skill information 123 to the control unit 130 (Step s403).

The control unit 130 that acquired the item information in the table in the requested skill information 123 creates an input screen and displays the failure handling terminal 300 (Step s404).

Then, the contact person inputs various kinds of information in the input screen that are displayed on the failure handling terminal 300 (Step s405). At this time, the contact person may also input a skill by using a method of selecting the skill from the list.

The control unit 130 in the failure management server 100 that received the input from the failure handling terminal 300 stores the handling action content as a file (Step s406). Then, the control unit 130 inputs the failure ID and the saved file path to the failure handling record DB 120A (Step s407).

The failure handling record DB 120A that received the input extracts the record that has the input ID (Step s408). Then, the failure handling record DB 120A sets the file path in the item of the “handling action content file path” (Step s409). Then, the failure handling record DB 120A changes the failure status from “being investigated” to “completed” and notifies the control unit 130 of the change (Step s410). The control unit 130 that received the notification from the failure handling record DB 120A performs the process at Step s411 illustrated in FIG. 37.

As illustrated in FIG. 37, the control unit 130 inputs the input ID and the skill to the failure handling record DB 120A (Step s411).

The failure handling record DB 120A that received the input adds a new record to the requested skill information 123 (Step s412). Then, the failure handling record DB 120A sets the failure ID (Step s413). Then, the failure handling record DB 120A sets “Yes” in the item of the corresponding skill, sets “No” in the other items, and notifies the control unit 130 of the result (Step s414).

The control unit 130 that received the notification from the failure handling record DB 120A inputs the input ID to the failure handling person DB 120B (Step s415).

The failure handling person DB 120B that received the input extracts the record that has the input ID from the engineer information 124 (Step s416). Then, the failure handling person DB 120B decrements the number of tasks of the extracted record by 1 and notifies the control unit 130 of the result (Step s417).

The control unit 130 that received the notification from the failure handling person DB 120B inputs the engineer ID and the input skill to the failure handling person DB 120B (Step s418).

The failure handling person DB 120B that received the input extracts the record that has the input ID from the holding skill information 125 (Step s419). Then, the failure handling person DB 120B sets “experienced” to each of the items of the input skill in the extracted record and notifies the control unit 130 of it (Step s420).

The control unit 130 that received the notification from the failure handling person DB 120B notifies the failure handling terminal 300 (contact person) of the completion of the input (Step s421).

The failure handling terminal 300 (contact person) that received from the control unit 130 in the failure management server 100 checks the completion of the input (Step s422), whereby the registration process has been completed.

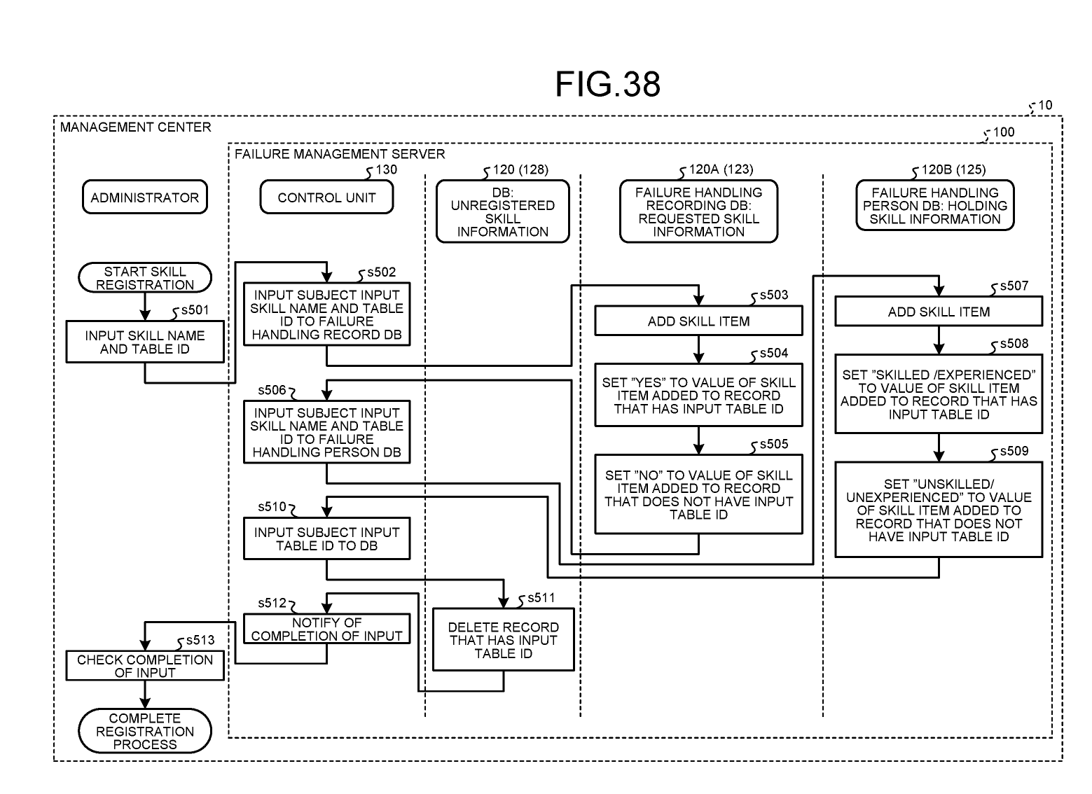

In the following, the additional process of the skill item will be described with reference to FIG. 38. FIG. 38 is a schematic diagram illustrating an example of the flow of a process of adding a skill item.

First, the administrator of the management center 10 inputs the skill name and the table ID to the failure management server 100 (Step s501). Furthermore, the administrator may also input the skill name and the table ID to the failure management server 100 via the dedicated terminal or may also directly input the subject data to the failure management server 100.

The control unit 130 in the failure management server 100 that received the input from the administrator of the management center 10 inputs the input skill name and the table ID to the failure handling record DB 120A (Step s502).

The failure handling record DB 120A that received the input adds a skill item to the requested skill information 123 (Step s503). Then, the failure handling record DB 120A sets “Yes” to the value of the skill item added to the record that has the input table ID in the requested skill information 123 (Step s504). Furthermore, the failure handling record DB 120A sets “No” to the value of the skill item added to the record that does not have the input table ID and notifies the control unit 130 of the result (Step S505).

The control unit 130 that received the notification from the failure handling record DB 120A inputs the input skill name and the table ID to the failure handling person DB 120B (Step s506).

The failure handling person DB 120B that received the input adds a skill item to the holding skill information 125 (Step s507). Then, the failure handling person DB 120B sets “skilled/experienced” to the value of the skill item added to the record that has the input table ID (Step S508). Furthermore, the failure handling person DB 120B sets the “unskilled/unexperienced” to the value of the skill item added to the record that does not have the input table ID and notifies the control unit 130 of the result (Step s509).

The control unit 130 that received the notification from the failure handling person DB 120B inputs the input table ID to the storing unit 120 (hereinafter, referred to as a DB 120) (Step s510).

The DB 120 that received the input deletes the record that has the input table ID from the unregistered skill information 128 and notifies the control unit 130 of the result (Step s511).

The control unit 130 that received the notification from the DB 120 notifies the administrator of the management center 10 that the input has been completed (Step s512).

The administrator of the management center 10 received from the control unit 130 in the failure management server 100 checks the completion of the input (Step s513), whereby the registration process has been completed.

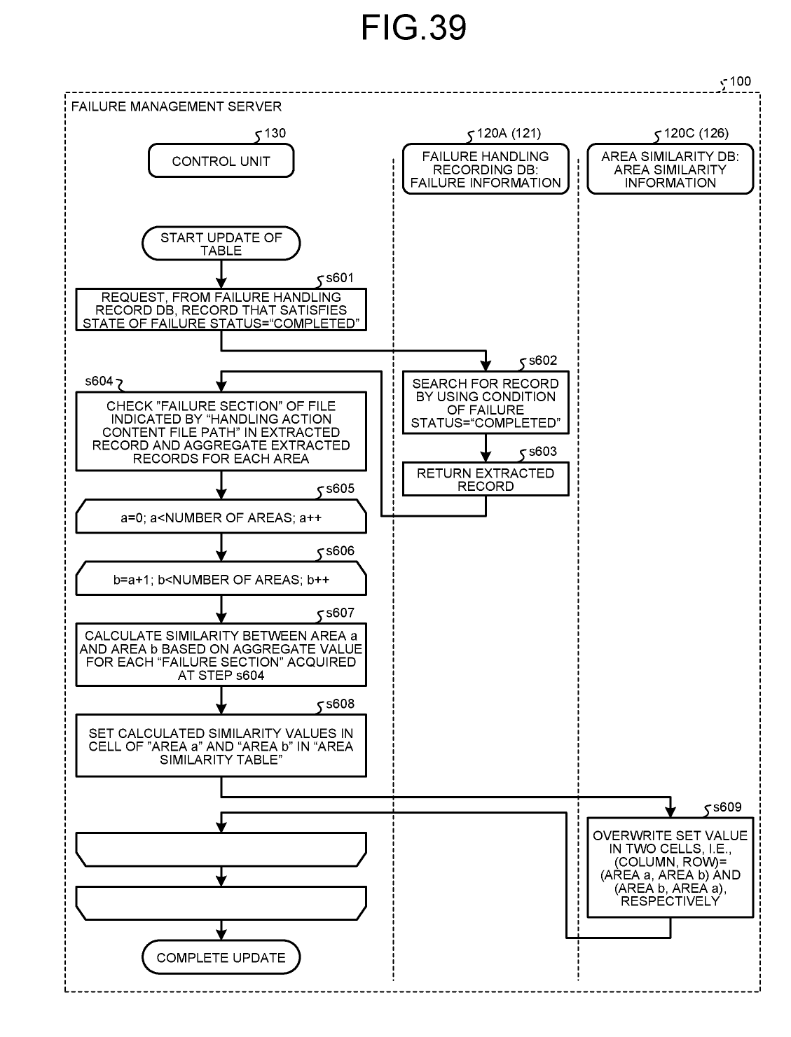

In the following, a process of updating the area similarity will be described with reference to FIG. 39. FIG. 39 is a schematic diagram illustrating an example of the flow of a process of updating the area similarity.

The control unit 130 in the failure management server 100 requests, from the failure handling record DB 120A, the record in which the failure status is “completed” (Step s601).

The failure handling record DB 120A that received the request searches the failure information 121 for the record by using the condition that the failure status is “completed” (Step s602). Then, the failure handling record DB 120A returns the extracted record that is extracted from the failure information 121 to the control unit 130 (Step s603).

The control unit 130 that acquired the extracted record from the failure handling record DB 120A checks the “failure section” of the file indicated by the “handling action content file path” in the extracted record and aggregates the extracted records for each area (Step s604).

Then, after the control unit 130 sets the variable a to 0, the control unit 130 performs the process at Steps s606 to s608 and repeats the process of incrementing the variable a by 1 by the number of times corresponding to the number of areas (Step s605). Furthermore, after the control unit 130 sets the variable b to the value obtained by incrementing the variable a by 1, the control unit 130 performs the processes at Steps s607 and s608 and repeats the process of incrementing the variable b by 1 until the variable b reaches the number of areas (Step s606). First, the control unit 130 calculates the similarity of the area a to the area b on the basis of the aggregate value for each “failure section” acquired at Step s604 (Step s607). Then, the control unit 130 sets the calculated similarity values in the cell of the “area a” and the “area b” in the “area similarity table” and notifies the area similarity DB 120C of the result (Step s608).

The area similarity DB 120C that received the notification from the control unit 130 overwrites the set value in the two cells, i.e., (column, row)=(area a, area b) and (area b, area a), respectively, and notifies the control unit 130 of the result (Step s609).

The control unit 130 that received the notification from the area similarity DB 120C returns to Step s606 and repeats the process. After the control unit 130 ends the process repeatedly performed at Steps s605 to s608, the control unit 130 ends the registration of the update.

### ADVANTAGES

As described above, the information processing apparatus according to the embodiment (in the embodiment, the failure management server 100) includes the receiving unit 131 and the specifying unit 133. The receiving unit 131 receives a notification indicating that a failure occurs in each of the data centers 11 arranged in a plurality of locations. The specifying unit 133 compares the area information that indicates the characteristic related to the occurrence of the failure in the data center 11 in which the failure has occurred with the area information that is associated with an engineer on the basis of the task and specifies the engineer who is associated with the area information that is similar to the area information on the data center 11 in which the failure has occurred by giving a higher priority to the engineer than engineers belonging to the other data center. Consequently, the failure management server 100 can speed up the handling of the failure that has occurred in the data center.

Furthermore, in the failure management server 100 according to the embodiment, the specifying unit 133 compares area information that is associated with the characteristic related to the occurrence of a past failure in the data center 11 in which the failure occurred with the area information that is associated with the engineer on the basis of the task and specifies the engineer who is associated with the area information that is similar to the area information on the data center 11 in which the failure has occurred by giving a higher priority to the engineer than engineers belonging to the other data center. Consequently, because the failure management server 100 specifies the engineer on the basis of the area information that is associated with the characteristic related to the occurrence of the past failure in the data center, the failure management server 100 can further speed up the handling of the failure that has occurred in the data center.

Furthermore, in the failure management server 100 according to the embodiment, the specifying unit 133 compares the area information that is associated with the geographical characteristic of the data center 11 in which a failure has occurred with the area information that is associated with the engineer on the basis of the task and specifies the engineer who is associated with the area information that is similar to the area information on the data center 11 in which the failure has occurred by giving a higher priority to the engineer than engineers belonging to the other data center. Consequently, because the failure management server 100 specifies the engineer on the basis of the area information by taking into account the geographical characteristic of the data center, the failure management server 100 can further speed up the handling of the failure that has occurred in the data center.

Furthermore, in the failure management server 100 according to the embodiment, the specifying unit 133 compares the area information on the data center in which a failure has occurred with the area information that is associated with the engineer on the basis of the area information on the data center that was handled by the engineer who handled the failure in the past and who is associated with the area information that is similar to the area information on the data center in which the failure has occurred by giving a higher priority to the engineer than engineers belonging to the other data center. Consequently, because the failure management server 100 specifies the engineer on the basis of the area information on the location of the data center in which the engineer performed failure handling in the past, the failure management server 100 can further speed up the handling of the failure that has occurred in the data center.

Furthermore, the components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, each of the processing units, such as the receiving unit 131, the extracting unit 132, the specifying unit 133, and the transmitting unit 134, may also be integrated as a single unit. Furthermore, the process performed by each of the processing units may also be appropriately separated into processes performed by a plurality of processing units. Furthermore, all or any part of the processing functions performed by each device can be implemented by a CPU and by programs analyzed and executed by the CPU or implemented as hardware by wired logic.

Information Processing Program

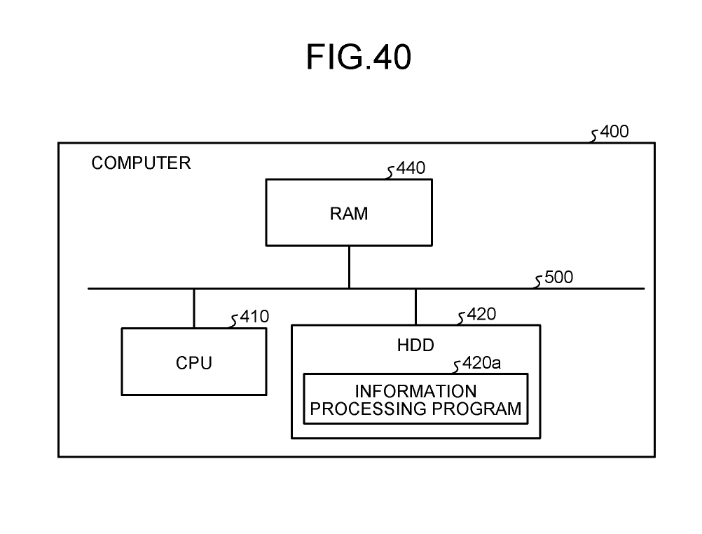

Furthermore, various kinds of processes described in the above embodiment can be implemented by executing programs prepared in advance for a computer system, such as a personal computer, a workstation, or the like. Accordingly, in the following, a description will be given of an example of a computer system that executes a program having the same function as that performed in the embodiment described above. FIG. 40 is a block diagram illustrating a computer that executes an information processing program.

As illustrated in FIG. 40, a computer 400 includes a central processing unit (CPU) 410, a hard disk drive (HDD) 420, and a random access memory (RAM) 440. The units 410 to 440 are connected with each other via a bus 500.

The HDD 420 stores therein, in advance, an information processing program 420a having the same function as the performed by the receiving unit 131, the extracting unit 132, the specifying unit 133, and the transmitting unit 134 described above. The information processing program 320a may also appropriately be separated.

Furthermore, the HDD 420 stores therein various kinds of information. For example, the HDD 420 stores therein various kinds of data that are used for the OS or production planning.

Then, the CPU 410 reads the information processing program 420a from the HDD 420 and executes the program, whereby the information processing program 420a executes the same operation as that executed by each of the processing units in the embodiment. Namely, the information processing program 420a executes the same operation as that performed by the receiving unit 131, the extracting unit 132, the specifying unit 133, and the transmitting unit 134.

Furthermore, the information processing program 320a described above is not always needed to be initially stored in the HDD 420.

For example, the program is stored in a “portable physical medium”, such as a flexible disk (FD), a CD-ROM, a DVD disk, a magneto-optic disk, an IC CARD, or the like, that is to be inserted into the computer 400. Then, the computer 400 may read and execute the program from the portable physical medium.

Furthermore, the program may also be stored in “another computer (or a server)” connected to the computer 400 via a public circuit, the Internet, a LAN, a WAN, or the like. Then, the computer 400 may also read and execute the program from the other computer.

According to an aspect of an embodiment of the present invention, an advantage is provided in that it is possible to speed up handling of a failure that has occurred in a data center.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a receiving unit that receives information on a failure that has occurred in each of data centers arranged in a plurality of locations; and
a specifying unit that compares area information that indicates a characteristic related to a failure in the data center in which the failure has occurred with area information that is associated with an engineer based on a task, and that specifies, as a failure handling candidate from among engineers, an engineer who is associated with area information that is similar to the area information that indicates the characteristic related to the failure in the data center in which the failure has occurred.

2. The information processing apparatus according to claim 1, wherein
the specifying unit compares area information that is associated with a characteristic related to a past failure in the data center in which the failure has occurred with the area information that is associated with the engineer based on the task, and specifies, as the failure handling candidate, an engineer who is associated with area information that is similar to the area information that is associated with the characteristic related to the past failure in the data center in which the failure has occurred.

3. The information processing apparatus according to claim 1, wherein
the specifying unit compares area information that is associated with a geographical characteristic of the data center in which the failure has occurred with the area information that is associated with the engineer based on the task, and specifies, as the failure handling candidate, an engineer who is associated with area information that is similar to the area information that is associated with a geographical characteristic of the data center in which the failure has occurred.

4. The information processing apparatus according to claim 1, wherein
the specifying unit compares area information on the data center in which the failure has occurred with area information that is associated with the engineer based on area information on the data center in which the past failure was handled, and specifies, as the failure handling candidate, an engineer who is associated with area information that is similar to the area information on the data center in which the failure has occurred.

5. A non-transitory computer-readable recording medium having stored therein an information processing program that causes a computer to execute a process comprising:
receiving information on a failure that has occurred in each of data centers arranged in a plurality of locations;
comparing area information that indicates a characteristic related to a failure in the data center in which the failure has occurred with area information that is associated with an engineer based on a task; and
specifying, as a failure handling candidate from among engineers, an engineer who is associated with area information that is similar to the area information that indicates the characteristic related to the failure in the data center in which the failure has occurred.

6. The non-transitory computer-readable recording medium according to claim 5, wherein
the comparing compares area information that is associated with a characteristic related to a past failure in the data center in which the failure has occurred with the area information that is associated with the engineer based on the task, and
the specifying specifies, as the failure handling candidate, an engineer who is associated with area information that is similar to the area information that is associated with the characteristic related to the past failure in the data center in which the failure has occurred.

7. The non-transitory computer-readable recording medium according to claim 5, wherein
the comparing compares area information that is associated with a geographical characteristic of the data center in which the failure has occurred with the area information that is associated with the engineer based on the task, and
the specifying specifies, as the failure handling candidate, an engineer who is associated with area information that is similar to the area information that is associated with a geographical characteristic of the data center in which the failure has occurred.

8. The non-transitory computer-readable recording medium according to claim 5, wherein
the comparing compares area information on the data center in which the failure has occurred with area information that is associated with the engineer based on area information on the data center in which the past failure was handled, and
the specifying specifies, as the failure handling candidate, an engineer who is associated with area information that is similar to the area information on the data center in which the failure has occurred.

9. An information processing method comprising:
receiving, performed by a computer, information on a failure that has occurred in each of data centers arranged in a plurality of locations;
comparing, performed by the computer, area information that indicates a characteristic related to a failure in the data center in which the failure has occurred with area information that is associated with an engineer based on a task; and
specifying, performed by the computer, as a failure handling candidate from among engineers, an engineer who is associated with area information that is similar to the area information that indicates the characteristic related to the failure in the data center in which the failure has occurred.

10. The information processing method according to claim 9, wherein
the comparing compares area information that is associated with a characteristic related to a past failure in the data center in which the failure has occurred with the area information that is associated with the engineer based on the task, and
the specifying specifies, as the failure handling candidate, an engineer who is associated with area information that is similar to the area information that is associated with the characteristic related to the past failure in the data center in which the failure has occurred.

11. The information processing method according to claim 9, wherein
the comparing compares area information that is associated with a geographical characteristic of the data center in which the failure has occurred with the area information that is associated with the engineer based on the task, and
the specifying specifies, as the failure handling candidate, an engineer who is associated with area information that is similar to the area information that is associated with a geographical characteristic of the data center in which the failure has occurred.

12. The information processing method according to claim 9, wherein
the comparing compares area information on the data center in which the failure has occurred with area information that is associated with the engineer based on area information on the data center in which the past failure was handled, and
the specifying specifies, as the failure handling candidate, an engineer who is associated with area information that is similar to the area information on the data center in which the failure has occurred.

13. A data center system comprising:
data centers arranged in a plurality of locations; and
an information processing apparatus that includes
a receiving unit that receives information on a failure that has occurred in each of the data centers, and
a specifying unit that compares area information that indicates a characteristic related to a failure in the data center in which the failure has occurred with area information that is associated with an engineer based on a task, and that specifies, as a failure handling candidate from among engineers, an engineer who is associated with area information that is similar to the area information that indicates the characteristic related to the failure in the data center in which the failure has occurred.

14. The data center system according to claim 13, wherein
the specifying unit compares area information that is associated with a characteristic related to a past failure in the data center in which the failure has occurred with the area information that is associated with the engineer based on the task, and specifies, as the failure handling candidate, an engineer who is associated with area information that is similar to the area information that is associated with the characteristic related to the past failure in the data center in which the failure has occurred.

15. The data center system according to claim 13, wherein
the specifying unit compares area information that is associated with a geographical characteristic of the data center in which the failure has occurred with the area information that is associated with the engineer based on the task, and specifies, as the failure handling candidate, an engineer who is associated with area information that is similar to the area information that is associated with a geographical characteristic of the data center in which the failure has occurred.

16. The data center system according to claim 13, wherein
the specifying unit compares area information on the data center in which the failure has occurred with area information that is associated with the engineer based on area information on the data center in which the past failure was handled, and specifies, as the failure handling candidate, an engineer who is associated with area information that is similar to the area information on the data center in which the failure has occurred.
